(19) United States
(12) Patent Application Publication
(10) Pub. No.: US 2017/0004122 A1
(43) Pub. Date: Jan. 5, 2017

(54) HANDWRITTEN CHARACTER CORRECTION APPARATUS, HANDWRITTEN CHARACTER CORRECTION METHOD, AND NON-TRANSITORY COMPUTER-READABLE RECORDING MEDIUM

(71) Applicant: FUJITSU LIMITED, Kawasaki-shi (JP)

(72) Inventors: Yuji Taniguchi, Yokohama (JP); Yasuhiro Tsuyuki, Numazu (JP); Hideto Higashi, Yokohama (JP); Masahiro Kataoka, Kamakura (JP)

(73) Assignee: FUJITSU LIMITED, Kawasaki-shi (JP)

(21) Appl. No.: 15/198,415

(22) Filed: Jun. 30, 2016

(30) Foreign Application Priority Data
Jul. 1, 2015 (JP) 2015-132973

(51) Int. Cl. G06F 17/24; G06K 9/34; G06K 9/00

(52) U.S. Cl. CPC G06F 17/24; G06K 9/00416; G06K 9/344; G06K 9/00422

(57) ABSTRACT

A method that includes correcting at least one of a character image of a target replacement character or stroke information of the target replacement character, in response to a designation of a specific character among recognized characters from handwriting input and an input of the target replacement character that is to replace the specific character, and updating at least one of a character image of the recognized characters or a stroke image of the recognized characters by utilizing at least a corrected one of the character image or the stroke information. The at least one of the character image or the stroke information is corrected based on coordinate information corresponding to the specific character. The coordinate information is generated from at least one of the character image of the recognized characters or the stroke image of the recognized characters that are stored in a memory.

### CROSS-REFERENCE TO RELATED APPLICATIONS

This application is based upon and claims the benefit of priority of the prior Japanese Patent Application No. 2015-132973 filed on Jul. 1, 2015, the entire contents of which are incorporated herein by reference.

### FIELD

The embodiments discussed herein are related to a handwritten character correction apparatus, a handwritten character correction method, and a non-transitory computer-readable recording medium.

### BACKGROUND

In one conventional technique of handwritten character recognition, an individual's handwriting image and stroke information are stored as authentication information and used for matching with an input character.

In a case of matching an input character with authentication information stored in a server, a recognized image or a stroke corresponding to authentication information is matched with the results of recognizing a stroke(s) of a handwritten character (matching target). Therefore, the handwriting image and the stroke information registered as authentication information in the server is to be correctly recognized for performing handwritten character recognition.

In a case where a part of a recognized character is erroneously recognized during the registration of the authentication information, it is desired to correct only the registration contents of the erroneously recognized character.

In connection with the correction of a part of the recognition results, there are known a technique of replacing only an image of a part of a handwriting image or a technique of determining which character image corresponds to a character based on the position of a stroke or the time of the stroke (see, for example, Japanese Laid-Open Patent Publication No. 2011-258129).

### SUMMARY

According to an aspect of the invention, there is provided a non-transitory computer-readable recording medium storing therein a program that causes a computer to execute a process. The process includes correcting at least one of a character image of a target replacement character or stroke information of the target replacement character, in response to a designation of a specific character among recognized characters from handwriting input and an input of the target replacement character that is to replace the specific character, and updating at least one of a character image of the recognized characters or a stroke image of the recognized characters by utilizing at least a corrected one of the character image or the stroke information. The at least one of the character image or the stroke information is corrected based on coordinate information corresponding to the specific character. The coordinate information is generated from at least one of the character image of the recognized characters or the stroke image of the recognized characters that are stored in a memory.

The object and advantages of the invention will be realized and attained by means of the elements and combinations particularly pointed out in the claims.

It is to be understood that both the foregoing general description and the followed detailed description are exemplary and explanatory and are not restrictive of the invention, as claimed.

### BRIEF DESCRIPTION OF DRAWINGS

FIG. 1 is a schematic diagram illustrating a configuration of programs according to the first embodiment of the present invention;

FIGS. 2A-2C are schematic diagrams illustrating the correction of a character string according to a recognition result according to an embodiment of the present invention;

FIGS. 3A and 3B are schematic diagrams illustrating the positional relationship and size ratio between images of characters;

FIG. 4 is a schematic diagram illustrating the compositing of a handwriting image and a character image according to an embodiment of the present invention;

FIGS. 5A and 5B are diagrams for describing the erasing of an image of a target correction character (part 1);

FIG. 6 is another diagram for describing the erasing of an image of a target correction character (part 2);

FIG. 7 is a schematic diagram illustrating a hardware configuration of a handwritten character correction apparatus according to an embodiment of the present invention;

FIG. 8 is a functional block diagram of a handwritten character correction apparatus according to the first embodiment of the present invention;

FIG. 9 is a schematic diagram illustrating a configuration of a character information database according to an embodiment of the present invention;

FIG. 10 is a sequence diagram illustrating the processes of each unit included in a handwritten character correction apparatus according to an embodiment of the present invention;

FIG. 11 is a flowchart illustrating an operation performed by an application execution unit according to an embodiment of the present invention;

FIG. 12 is a first flowchart illustrating an operation performed by a handwritten character correction process unit according to an embodiment of the present invention;

FIGS. 13A and 13B are schematic diagrams illustrating a label attaching process by a label-attached image generation unit according to an embodiment of the present invention;

FIG. 14 is a schematic diagram illustrating the intersection of stroke images;

FIG. 15 is a schematic diagram illustrating a configuration of an intersection area list database according to an embodiment of the present invention;

FIG. 16 is a flowchart illustrating an operation of a recognition process unit according to an embodiment of the present invention;

FIG. 17 is a second flowchart illustrating an operation performed by a handwritten character correction process unit according to an embodiment of the present invention;

FIG. 18 is a schematic diagram illustrating the updating process of an intersection area list according to an embodiment of the present invention;

FIGS. 19A-19C are schematic diagrams illustrating the process of erasing a stroke image according to an embodiment of the present invention;

FIGS. 20A and 20B are schematic diagrams illustrating the effects of a label attaching process according to an embodiment of the present invention;

FIG. 21 is a schematic diagram illustrating a process performed by a circumscribing frame-size changing unit according to an embodiment of the present invention;

FIG. 22 is a schematic diagram illustrating a process performed by a database update unit according to an embodiment of the present invention;

FIG. 23 is a schematic diagram illustrating a handwritten character correction apparatus according to the second embodiment of the present invention; and

FIG. 24 is a schematic diagram illustrating a handwritten character correction apparatus according to the third embodiment of the present invention.

### DESCRIPTION OF EMBODIMENTS

In a case of replacing a part of an image of a handwriting image, there is a possibility of unintentionally erasing a part of an adjacent character when one character and the adjacent character interfere with each other. Further, images of characters that are separated according to stroke information may be inaccurate (e.g., inaccurate stroke thickness) in an area where characters overlap with each other. Thus, the images of the characters may not be suitable as a handwriting image used for authentication.

### First Embodiment

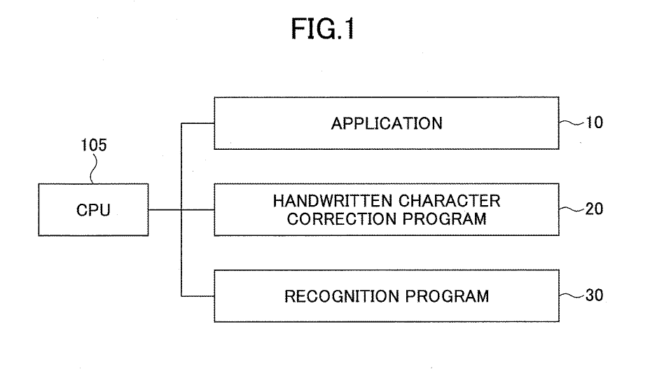

Embodiments of the present invention are described with reference to the accompanying drawings. FIG. 1 is a schematic diagram illustrating a configuration of programs according to the first embodiment of the present invention.

The programs of this embodiment include an application 10, a handwritten character correction program 20, and a recognition program 30.

The application 10 provides the below-described function that can be implemented by the application 10. In a case where the application 10 provides a function to a user, the application 10 may request authentication of the user. The authentication requested by the application 10 may be, for example, a log-in process that is performed when a service is provided from a server to a user.

Further, in a case of performing authentication, the application 10 may receive input of a handwritten stroke and send information indicating the handwritten stroke to the recognition program 20. Further, the application 10 sends an image of each stroke to the handwritten character correction program 20. In the following description, stroke information indicating a stroke and an image of each stroke is referred to as “stroke information”. The application 10 displays recognition results of a stroke and stores the stroke information and a character string of the recognition results as character information in a storage unit 140.

The handwritten character correction program 20 stores the stroke image from the application 10 in the storage unit 140. Further, in a case where a character string including a recognized stroke is instructed to be corrected, the handwritten character correction program 20 updates the stored character information in accordance with the instruction.

The recognition program 30 recognizes an input stroke from the stroke information received from the application 10 and outputs a character string according to the recognition results. In a case where a character is recognized, coordinate information indicating a circumscribing frame circumscribing the character is output together with a character string of the recognition results. In the following description, the character string recognized by the recognition program 30 is referred to as “recognized character string”. Note that “a character string” according to an embodiment of the present invention may be constituted by a single character or multiple characters.

Each of the application 10, the handwritten character correction program 20, and the recognition program 30 may be installed separate apparatuses or installed together in a single apparatus.

In the below-described first embodiment of the present invention, the application 10, the handwritten character correction program 20, and the recognition program 30 are installed in a single apparatus. Further, in the below-described first embodiment of the present invention, an apparatus installed with the application 10, the handwritten character correction program 20, and the recognition program 30 is referred to as “handwritten character correction apparatus”.

Next, a process of correcting a recognized character string with the handwritten character correction apparatus according to an embodiment of the present invention is described.

The application 10 of this embodiment obtains stroke information and a handwriting image including a stroke image(s) as authentication information. The authentication information is associated with a recognized character string of the stroke information.

Therefore, in a case where the character recognition based on the stroke information is incorrect when, for example, authentication information is being registered, an incorrectly recognized character string would be associated with the stroke information and the stroke image. As a result, authentication cannot be correctly performed. The stroke information and the handwriting image serving as authentication information are to be associated with a correctly recognized character string.

Thus, according to this embodiment, in a case where a recognized character string includes an incorrectly recognized character, only the character that is incorrectly recognized is re-input by hand, and the incorrectly recognized character is replaced with a character recognized by a stroke(s) of the re-input character.

Further, according to this embodiment, an image of the incorrectly recognized character is erased from a handwriting image obtained during the incorrect recognition and is replaced with an image of a handwritten re-input character. Further, in a case of replacing the image of the incorrectly recognized character in the handwriting image with the image of the re-input character according to this embodiment, the replacement of characters is performed in a manner that the features of the handwriting before the replacement are not affected.

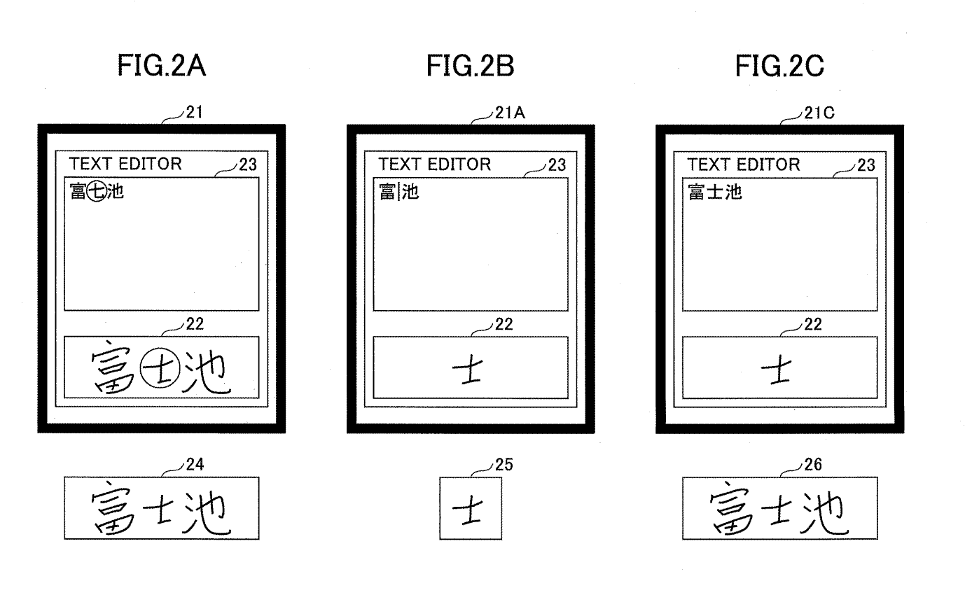

FIGS. 2A-2C are schematic diagrams illustrating the correction of a character string according to a recognition result according to an embodiment of the present invention. FIG. 2A illustrates the input of strokes and the display of a character string according to a recognition result. FIG. 2B illustrates a correction process performed on a recognized character string. FIG. 2C illustrates the correction of a handwriting image.

The application 10 of the first embodiment encourages a user whose authentication information is not yet registered to register his/her authentication information by way of handwritten input. More specifically, the application 10 instructs a handwriting input column 22 and a recognition result display column 23 to be displayed on the screen 21 of a handwritten character correction apparatus 100 and receives handwritten input via the handwriting input column 22. The recognition result display column 23 indicates an authentication result of a stroke of a handwritten input.

As illustrated in FIG. 2A, the handwriting input column 22 receives input of a character string “ [symbol] ” that is input by hand (handwritten input). In the case of FIG. 2A, a recognized character string “ [symbol] ” is obtained as a recognition result of the recognition program 30. Further, in the case of FIG. 2A, stroke information indicating a stroke(s) that is handwritten to the handwritten input column 22 and a handwriting image 24 including a stroke image are stored in a character information database. The character information database is described in further detail below.

In the example of FIG. 2A, the recognized character string is displayed in the recognition result display column in which a handwritten character “ [symbol] ” is erroneously recognized to be a character “ [symbol] ”. In this case, the handwritten character correction apparatus 100 identifies the character to be corrected (target correction character) by receiving a selection of the erroneously recognized character displayed on the recognition result display column 23. Then, the handwritten character correction apparatus 100 replaces the target correction character with a character recognized from a stroke (s) input to the handwriting input column 22.

The screen 21A illustrated in FIG. 2B displays a state in which the erroneously recognized character “ [symbol] ” is erased from the recognition result display column 23 and a handwritten character “ [symbol] ” is re-input to the handwriting input column 22. Further, in this embodiment, the image of the character that is handwritten into the handwriting input column 22 is obtained as a character image 25.

FIG. 2C illustrates a state in which the handwritten character “ [symbol] ” is correctly recognized and the recognized character string “ [symbol] ” is corrected to “ [symbol] ” in the recognition result display column 23.

Further, in this embodiment, the character “ [symbol] ” is erased from the handwriting image 24, and the image of the erased character is replaced with the character image 25 obtained in FIG. 2B, so that the handwriting image 24 becomes a handwriting image 26 illustrated in FIG. 2C.

In this embodiment, the image erased from the handwriting image 24 is replaced with the character image 25 in a manner that the features of the handwriting including the handwriting image 24 are not adversely affected when replacing the image erased from the handwriting image 24 with the character image 25 (described in further detail below).

Note that “the features of the handwriting” includes aspects such as the size ratio between adjacent characters or the positional relationship among characters.

In the example of FIGS. 2A-2C, the handwriting images 24, 26, and the character image 25 are not illustrated in the screens of the handwriting character correction apparatus 100. However, the handwriting images 24, 26, and the character image 25 may also be displayed in the screens of the handwriting character correction apparatus 100.

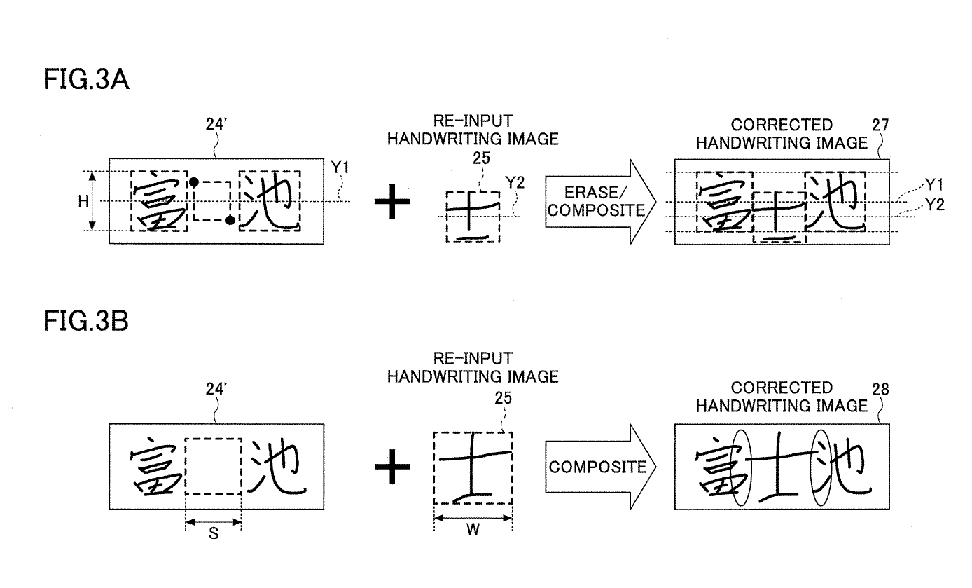

Next, the replacement of images of characters according to an embodiment of the present invention is described. FIGS. 3A and 3B are schematic diagrams illustrating the positional relationship and size ratio between images of characters. More specifically, FIG. 3A depicts a positional relationship between images of characters. FIG. 3B depicts a size ratio between images of characters.

Typically, in a case of writing a character as a single character constituting a character string, the size ratio between adjacent characters and the positional relationship between adjacent characters appear to be the features of one's handwriting. However, in a case of writing only a single character, the positional relationship between adjacent characters may not be considered to be the features of one's handwriting.

Therefore, in a case where an image of a character is re-input for correcting an erroneously recognized character according to an embodiment of the present invention, the positional relationship and the size ratio between images of other characters of a handwriting image may not be taken into consideration.

FIG. 3A illustrates a case where a horizontal axis of an image 25 of a re-input character does not match a horizontal axis of an image 24′ in which an image of an erroneously recognized character “ [symbol] ” is erased from the handwriting image 24. As illustrated in FIG. 3A, in a case where “H1” represents the height from the lower edge to the upper edge of the circumscribing frames of two characters “ [symbol] ” and “ [symbol] ” included in the image 24′, a line Y1 that divides the height “H1” in half is assumed to be the horizontal axis of the image 24′. Further, a line Y2 that divides the character image 25 into half is assumed to be the horizontal axis of the character image 25.

As illustrated in FIG. 3B, the width “w” of the circumscribing frame of the character image 25 is greater than the space “s” between the characters “ [symbol] ” and “ [symbol] ” of the image 24′. Therefore, in a case of a composited image 28 having the character image 25 composited to the image 24′, there may occur a phenomenon in which a part of the character “ [symbol] ” of the image 24′ and a part of the character “ [symbol] ” of the image 24′ become erased by the character image 25.

Thus, the character image 25 is composited to the image 24′ by taking the above-described aspects and phenomenon into consideration. That is, when compositing the character image 25 to the image 24′ according to the first embodiment, the compositing of the image 24′ is performed after the size of the character image 25 is adjusted to match the handwriting image 24. Further, when compositing the character image 25 to the image 24′ according to the first embodiment, the size-adjusted character image 25 is arranged to maintain the positional relationship with respect to the other two characters. That is, the size-adjusted character image 25 is to be arranged without changing the positional relationship with respect to the other two characters.

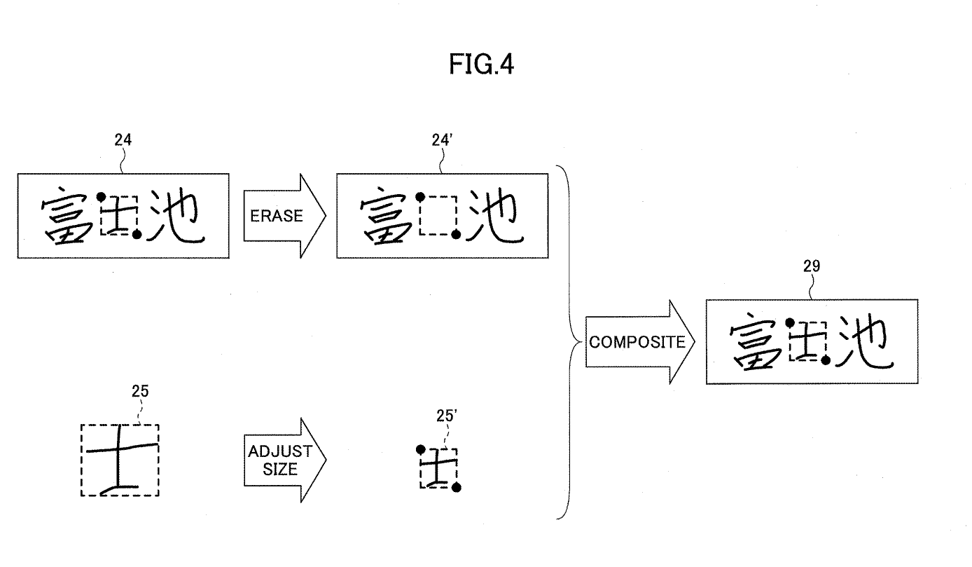

FIG. 4 is a schematic diagram illustrating the compositing of a handwriting image and a character image according to an embodiment of the present invention. In this embodiment, the image of the character “ [symbol] ” to be corrected (target correction character or target re-input character) is erased from the handwriting image 24 when the character “ [symbol] ” is selected as the target correction character from the recognized character string. Thereby, the image 24′ is obtained.

In this embodiment, an image 25′ is obtained by adjusting the size of the re-input character image 25 to match the size of the circumscribing frame of the erased character “ [symbol] ”. Thereby, a handwriting image 29 is generated by applying the image 25′ to a position that overlaps with the circumscribing frame of the erased character “ [symbol] ”. Note that the handwriting images 24, 29 illustrated in FIG. 4 correspond to the below-described label-attached images.

In this embodiment, a handwriting image can be changed without adversely affecting the features of one's handwriting by correcting the character image of the character to be corrected.

Further, this embodiment takes the following aspects into consideration when erasing an image of a character that is identified from a handwriting image in a case where a target correction character is identified from a recognized character string.

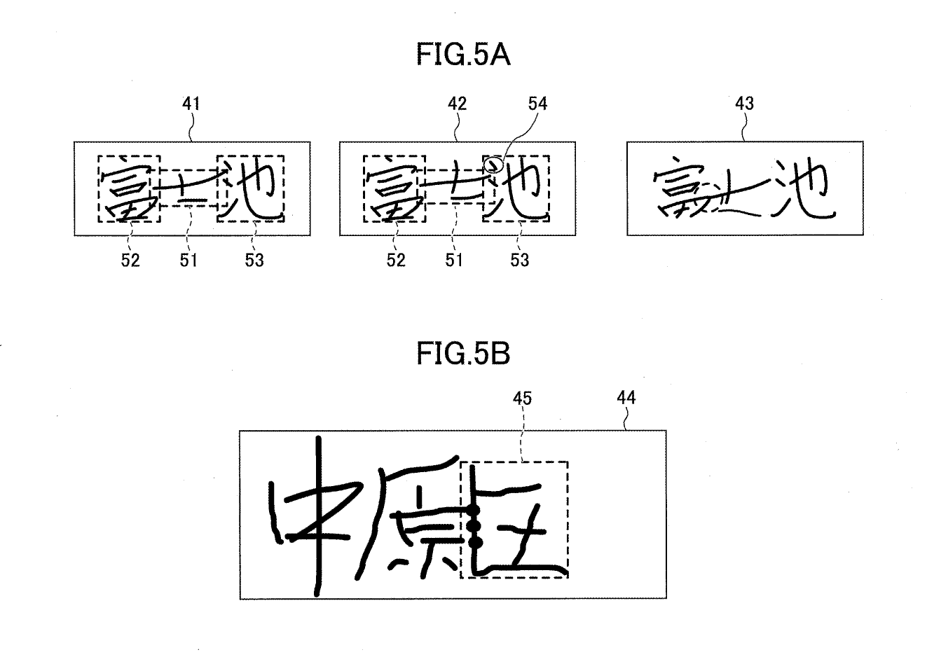

FIGS. 5A and 5B are diagrams for describing the erasing of an image of a target correction character (part 1). More specifically, FIG. 5A illustrates a case where a circumscribing frame 51 of a target correction character overlaps with the circumscribing frames 52, 53 of the characters adjacent to the target correction character. FIG. 5B illustrates a case where images (lines) of a character are overlapped.

In a handwriting image 41 illustrated on the left side of FIG. 5A, an circumscribing frame 51 of the target correction character “ [symbol] ” overlaps with each of the circumscribing frames 52, 53 of the adjacent characters “ [symbol] ” and “ [symbol] ”. However, the image of the target correction character “ [symbol] ” neither overlaps with the images of the characters “ [symbol] ” and “ [symbol] ”. In the state illustrated on the left side of FIG. 5A, a part of the image of the character “ [symbol] ” and a part of the image of the character “ [symbol] ” that are included in the circumscribing frame 51 become erased when the image of the target correction character is erased.

Further, in a handwriting image 42 illustrated at the center of FIG. 5A, the image of the target correction character “ [symbol] ” and the image of the adjacent character “ [symbol] ” overlap. In addition, an independent line is included in the area at which the image of the target correction character “ [symbol] ” and the image of the adjacent character “ [symbol] ” overlap. In the state illustrated in the center of FIG. 5A, a line 54 (first stroke of the three commas on the left side of the character “ [symbol] ”) included in the area where the circumscribing frame 51 and the circumscribing frame 52 overlap becomes erased when the image of the target correction character is erased. Further, because the independent line 54 included in the area where the circumscribing frame 51 and the circumscribing frame 52 overlap does not intersect with any of the circumscribing frames, the character of the circumscribing frame in which the independent line 54 is included cannot be determined based on whether the independent line 54 intersects with a circumscribing frame.

Further, in a handwriting image 43 illustrated on the right side of FIG. 5A, the image of the target correction character “ [symbol] ” overlap with the image of the adjacent character “ [symbol] ”. In the state illustrated on the right side of FIG. 5A, apart of the image of the character “ [symbol] ” becomes erased when the image of the target correction character is erased.

Further, in a case where a line included in an image of a target correction character “ [symbol] ” included in a handwriting image 44 overlaps with a line of an image of an adjacent character as illustrated in FIG. 5B, it is difficult to determine the thickness of the line at the area where the images of the characters overlap.

Thus, in view of the above-described difficulties described with FIGS. 5A and 5B, an embodiment of the present invention can erase a target correction character without adversely affecting an image of an adjacent character even in a case where an image of the target correction character and the image of the adjacent character overlap (interfere) with each other.

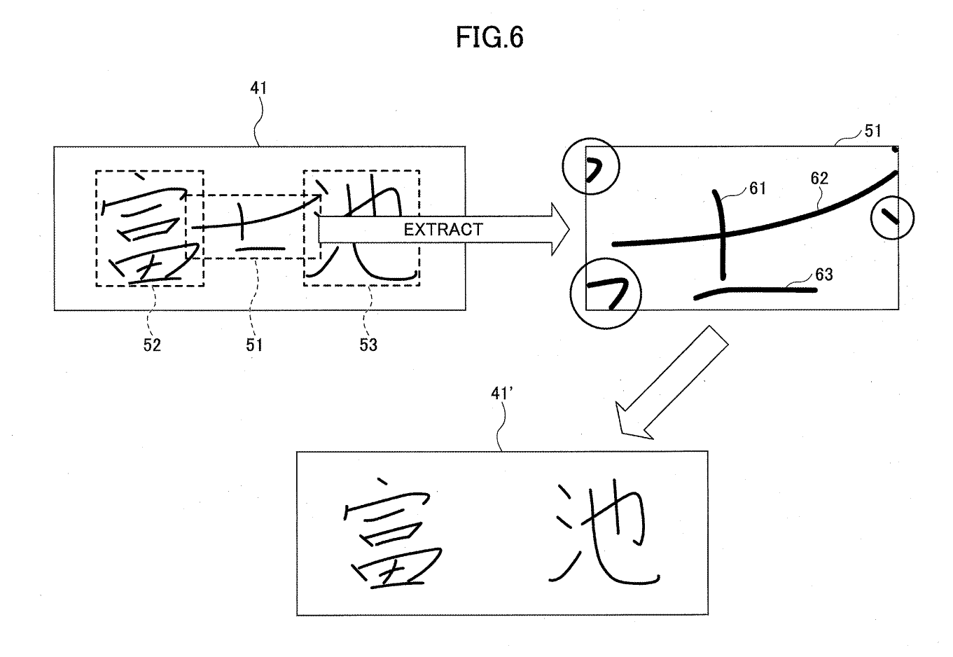

FIG. 6 is another diagram for describing the erasing of an image of a target correction character (part 2). According to an embodiment of the present invention, whenever a stroke is input by hand, a label is attached to an image of the stroke (stroke image). The label that is attached to each stroke image serves to identify each stroke image. The stroke image and its corresponding label are retained in association with each other.

Further, according to an embodiment of the present invention, a stroke image that constitutes an image of a target correction character is erased from a handwriting image when the target correction character is identified.

For example, in a case where a target correction character “ [symbol] ” is identified in the handwriting image 41, the stroke images 61, 62, 63 that constitute the character “ [symbol] ” are erased from the handwriting image 41. Note that the handwriting image 41 of FIG. 6 corresponds to the below-described label-attached image.

According to an embodiment of the present invention, a target correction character is erased from the handwriting image 41 in units of stroke images. Therefore, the target correction image “ [symbol] ” can be erased without affecting the images of the characters “ [symbol] ” and “ [symbol] ” that are positioned adjacent to the character “ [symbol] ”.

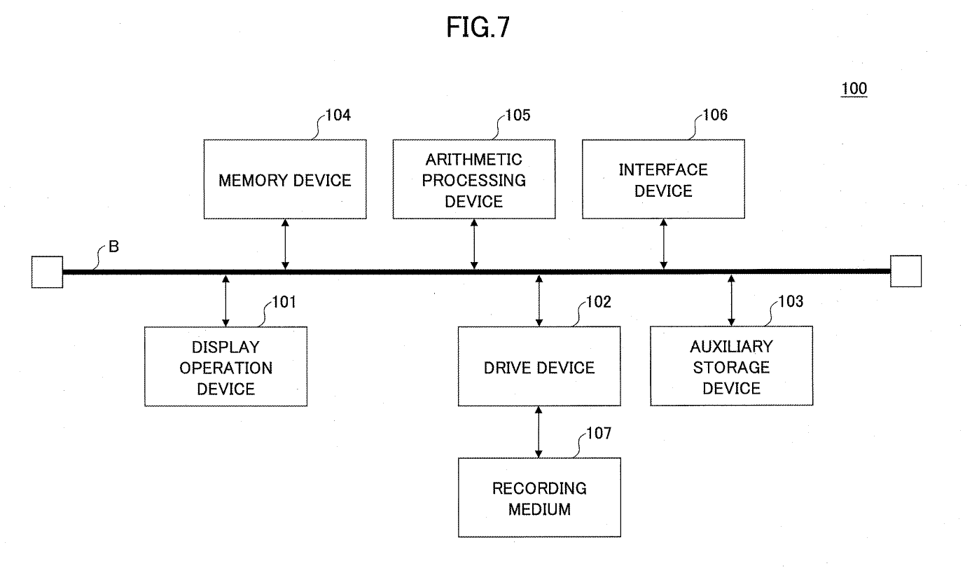

Next, an embodiment of the handwritten character correction apparatus 100 that executes the above-described processes is described. FIG. 7 is a schematic diagram illustrating a hardware configuration of the handwritten character correction apparatus 100 according to an embodiment of the present invention.

The handwritten character correction apparatus 100 includes a display operation device 101, a drive device 102, an auxiliary storage device 103, a memory device 104, an arithmetic processing device 105, and an interface device 106 that are connected to each other via a bus B.

The display operation device 101 includes, for example, a touch panel. The display operation device 101 is used for inputting various signals and displaying (outputting) various signals. The interface device 106 includes, for example, a modem and a LAN (Local Area Network) card. The interface device 106 is used for connecting the handwritten character correction apparatus 100 to a network.

The application 10, the handwritten character correction program 20, and the recognition program 30 are at least a part of the various programs that control the handwritten character correction apparatus 100. The programs may be provided to the handwritten character correction apparatus 100 by distribution of a non-transitory recording medium 107 on which the programs are recorded or by downloading the programs from a network. The non-transitory recording medium 107 on which the application 10, the handwritten character correction program 20, and the recognition program 30 are recorded may be, for example, a CD-ROM (Compact Disc-Read Only Memory), a flexible disk, or a magneto-optical disk that can optically, electrically, or magnetically record information. Alternatively, the non-transitory recording medium 107 may be other types of recording media such as a semiconductor memory including a ROM (Read Only Memory) or a flash memory that electrically records information.

In a case where the non-transitory recording medium 107 having the application 10, the handwritten character correction program 20, and the recognition program 30 recorded thereon is set to the drive device 102, each program recorded in the non-transitory recording medium 107 is installed in the auxiliary storage device 103 via the drive device 102. Each program downloaded from the network is installed in the auxiliary storage device 103 via the interface device 106.

The auxiliary storage device 103 stores the application 10, the handwritten character correction program 20, and the recognition program 30 installed in the handwritten character correction apparatus 100. The auxiliary storage device 103 also stores basic software (e.g., OS (Operating System)), necessary files, and data. The memory device 104 reads out each of the programs stored in the auxiliary storage device 103 upon activation of the program and stores the read out program therein. Then, the arithmetic processing device (e.g., CPU (Central Processing Unit)) 105 implements the below-described processes according to each program stored in the memory device 104.

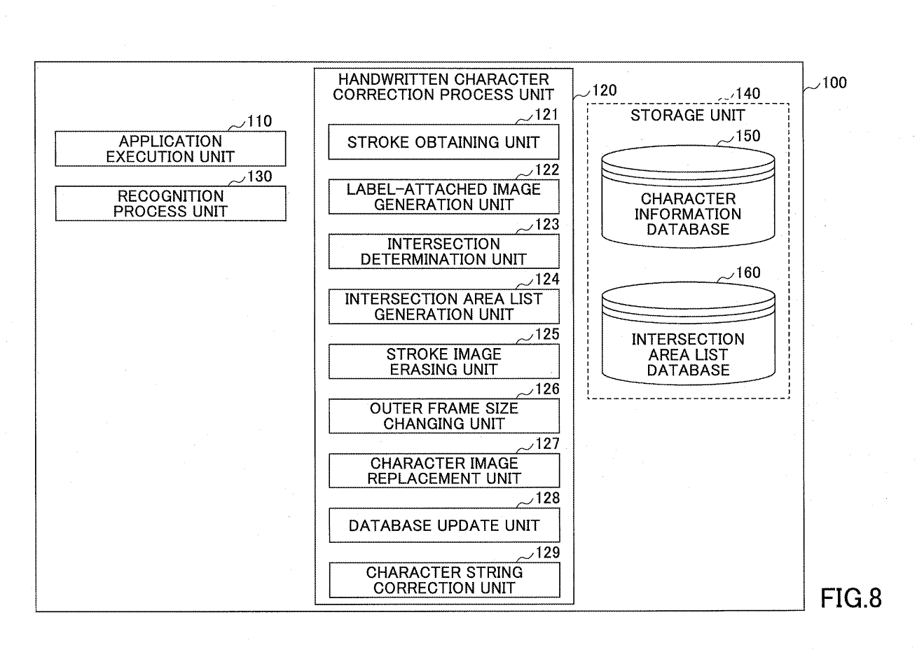

Next, the functions of the handwritten character correction apparatus 100 according to an embodiment of the present invention are described with reference to FIG. 8. FIG. 8 is a functional block diagram of the handwritten character correction apparatus according to the first embodiment of the present invention.

The handwritten character correction apparatus 100 includes an application execution unit 110, a handwritten character correction process unit 120, a recognition process unit 130, and a storage unit 140. The storage unit 140 stores a character information database 150 and an intersection area database 160.

A function of the application execution unit 110 is implemented by executing the application 10 with the arithmetic processing device 105. A function of the handwritten character correction process unit 120 is implemented by executing the handwritten character correction program 20 with the arithmetic processing unit 105. A function of the recognition process unit 130 is implemented by executing the recognition program 30. The storage unit 140 is implemented by way of, for example, the auxiliary storage device 103 and the memory device 104.

The application execution unit 110 displays a screen including the handwriting input column when the application 10 is activated. The application execution unit 110 receives a handwritten stroke that is input to the handwriting input column. Further, the application execution unit 110 receiving the input of the stroke sends stroke information to the recognition process unit 130. Further, the application execution unit 110 receiving the input of the stroke sends a stroke image to the handwritten character correction process unit 120.

The handwritten character correction process unit 120 generates an image attached with a label (identifier) that identifies a stroke image (label-attached image). The label is attached to each stroke image received from the application execution unit 110.

That is, the “label-attached image” according to an embodiment of the present invention is an image in which each stroke image constituting a handwriting image is attached with a label. The label-attached image is one type of handwriting image that represents a handwriting. In the following description, a handwriting image having no label attached to a stroke image (i.e., not identified in units of stroke images) is hereinafter simply referred to as a “handwriting image”.

Further, in a case where the handwritten character correction process unit 120 receives an instruction to correct a recognized character string, the handwritten character correction process unit 120 erases the target correction character from the label-attached image and adjusts the size of an image of a re-input character, so that the image of the re-input character is corrected to match the size of the target correction character prior to being erased from the label-attached image. Further, the handwritten character correction process unit 120 inserts the re-input character into a position of the target correction character prior to being erased from the label-attached image. Then, the handwritten character correction process unit 120 generates a corrected handwriting image based on the label-attached image having the target correction character replaced with the re-input character.

Details of the handwritten character correction process unit 120 are described below.

The recognition process unit 130 recognizes a character according to stroke information received from the application execution unit 110 and obtains a character as a result of the recognition process.

Next, the handwritten character correction process unit 120 according to an embodiment of the present invention is described in further detail. The handwritten character correction process unit 120 includes a stroke obtaining unit 121, a label-attached image generation unit 122, an intersection determination unit 123, an intersection area list generation unit 124, a stroke image erasing unit 125, a circumscribing frame-size changing unit 126, a character image replacement unit 127, a database update unit 128, and a character string correction unit 129.

The stroke obtaining unit 121 obtains a stroke image from the application execution unit 110. Further, the stroke obtaining unit 121 obtains stroke information and a stroke image from the application execution unit 110 when the handwritten character correction process unit 120 receives an instruction to correct a recognized character string. The stroke information includes information pertaining to a stroke that is re-input in correspondence with a target correction character. The stroke image includes an image of the stroke that is re-input in correspondence with a target correction character.

The label-attached image generation unit 122 attaches a label to each obtained stroke image and generates a label-attached image. The label-attached image generation unit 122 attaches a label to a stroke image associated with the label. In this embodiment, the label may be the number of strokes constituting the stroke that is input to the handwriting input column. Details of the label-attached image generation unit 122 are described below.

The intersection determination unit 123 determines whether a stroke image intersects another stroke image. The determination by the intersection determination unit 123 is performed on each stroke image.

The intersection area list generation unit 124 generates an intersection area list (described below) according to the determination results of the intersection determination unit 123. The intersection area list is stored in the intersection area list database 160. Details of the intersection area list database 160 are described below.

In a case where an instruction to correct a recognized character string is received by the handwritten character correction process unit 120 and the character to be corrected (target correction character) is identified, the stroke image erasing unit 125 erases a stroke image constituting the target correction character. Details of the stroke image erasing unit 125 are described below.

The circumscribing frame-size changing unit changes the size of the circumscribing frame of the character that is to be replaced (target replacement character) by the target correction character, so that the size of the circumscribing frame of the target replacement character matches the size of the circumscribing frame of the target correction character. In the following description, the character that is to be replaced by the target correction character is hereinafter referred to as “target replacement character” or “character of replacement destination”. The character of the replacement destination is a character recognized by a stroke that is re-input to the handwriting input column after the application execution unit 110 receives an instruction to correct a recognized character string.

After the size of the circumscribing frame of the target replacement character is changed by the circumscribing frame size changing unit 126, the character image replacement unit 127 replaces the target replacement character with the target correction character in a position matching the position of the target correction character. More specifically, the character image replacement unit 127 inserts an image of the target replacement character to a label-attached image from which a stroke image of the target correction character is erased. Thereby, a label-attached image having target replacement character replaced by the target correction character is generated.

That is, the circumscribing frame size changing unit 126 and the character image replacement part 127 according to an embodiment of the present invention serve as a correction unit that corrects the position of the target correction character to match the size of the character of the replacement destination.

The database update unit 128 updates the character information database 150. More specifically, the database update unit 128 updates the character information database 150, so that information related to the target correction character is updated to information related to the target replacement character. Each of the information related to the target correction character and the information related to the target replacement character may include, for example, stroke information of each character, the coordinates of a circumscribing frame, and a handwriting image. Details of the database update unit 128 are described below.

The character string correction unit 129 generates a corrected character string by correcting a character string recognized by the recognition process unit 130. More specifically, the corrected character string is generated by replacing an erroneously recognized character included in the recognized character string with a character recognized by a re-input stroke.

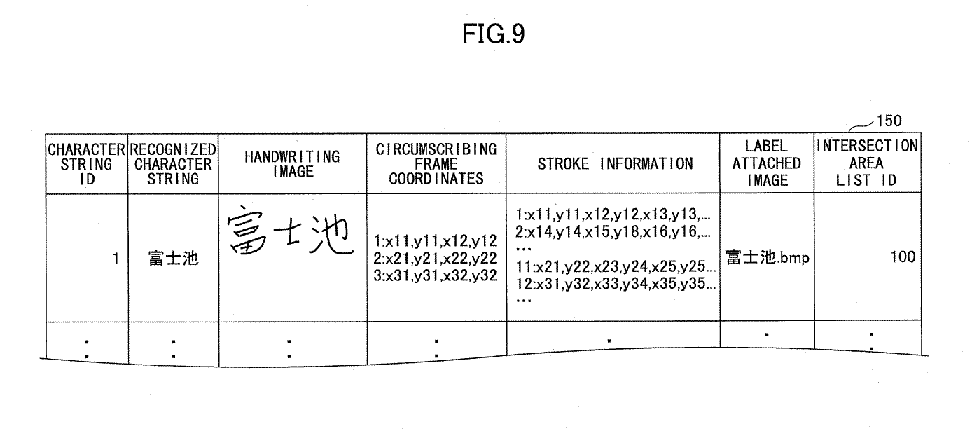

Next, the character information database 150 according to an embodiment of the present invention is described with reference to FIG. 9. FIG. 9 is a schematic diagram illustrating a configuration of the character information database 150 according to an embodiment of the present invention.

The character information database 150 includes data items such as “character string ID”, “recognized character string”, “handwriting image”, “circumscribing frame coordinates”, “label-attached image”, and “intersection area list ID”.

In the character information database 150 of this embodiment, the item “character string ID” is associated with the other data items of the character information database 150. In the following description, information that includes the value of the item “character string ID” and the values of the items associated with the item “character string ID” and the value of the item “character string” are hereinafter referred to as “character information”.

The value of the item “character string ID” is an identifier that is assigned to the character string recognized by the recognition process unit 130. The value of the item “recognized character string” is a character (text) recognized by the recognition process unit 130.

The value of the item “handwriting image” is a handwriting image (image file) including a stroke image. The value of the item “circumscribing frame coordinates” is the coordinates indicating the circumscribing frame of each character included in a recognized character string. In this embodiment, a quadrangular frame circumscribing a character is referred to as “circumscribing frame”. Further, in this embodiment, the term “circumscribing frame coordinates” refers to the coordinates of two points in which the first point is located on an upper left of a circumscribing frame whereas the second point is located on a lower right of the circumscribing frame.

Further, the value of the item “circumscribing frame coordinates” (coordinates of a circumscribing frame) is associated with a value that indicates the order (rank) of a circumscribed character of the character string (e.g., first character, second character . . . of the character string). For example, in a case where three characters constitute the recognized character string “ [symbol] [symbol] ” as illustrated in FIG. 9, three circumscribing frame coordinates (i.e., circumscribing frame coordinates of first character, circumscribing frame coordinates of second character, and circumscribing frame coordinates of third character) are stored as the values of the item “circumscribing frame coordinates”.

The value of the item “stroke information” indicates stroke information corresponding to a recognized character string. That is, the number of stroke information is equivalent to the total number of strokes of characters included in a recognized character string. In this embodiment, the stroke information is information indicating a stroke (handwriting) equivalent to a single stroke that is input by hand (handwritten input). In this embodiment, the stroke information includes two or more coordinates. That is, a single stroke can be identified by connecting the two or more coordinates included in the stroke information.

Note that the coordinates of this embodiment assumes the upper left edge of the handwriting input column (see FIGS. 2A-2C) displayed by the application execution unit 110 to be the reference point (origin) of the coordinates.

In the following description, the stroke information equivalent to the number of strokes of the characters included in a character string is hereinafter referred to as “stroke information group”. Further, in a stroke information group of this embodiment, the stroke information is associated with the number of strokes among a character string. More specifically, in a case where the recognized character string is “ [symbol] ”, the character “ [symbol] ” include the thirteenth to fifteenth stroke among the recognized character string from handwriting input. Accordingly, the stroke information of the three strokes constituting the character “ [symbol] ” are associated with the values indicating the thirteenth to fifteenth stroke (i.e., 13 to 15), respectively.

The value of the item “label-attached image” is a label-attached image (image file) generated by the label-attached image generation unit 122. Details of the label-attached image are described below.

The value of the item “intersection area list ID” is an ID that is assigned to an intersection area list when the intersection area list is generated. The intersection area list ID serves as an identifier for identifying an intersection area list.

Accordingly, whenever there is a pause (breakpoint) during the handwritten input of a character, a character image corresponding to the part of the pause (breakpoint) is stored in the character information database 150 in association with a stroke.

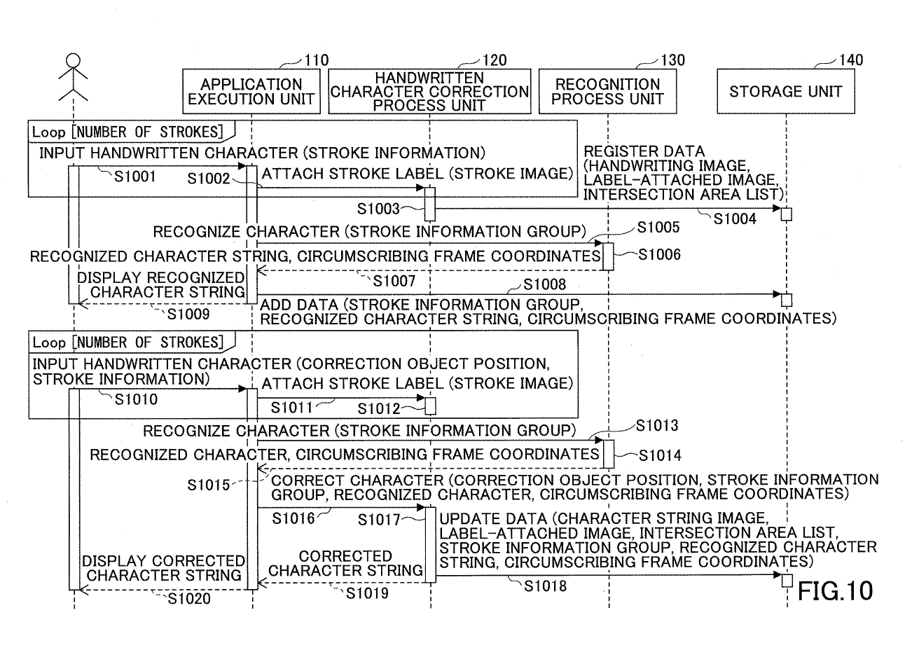

Next, an operation of the handwritten character correction apparatus 100 according to an embodiment of the present invention is described with reference to FIG. 10. FIG. 10 is a sequence diagram illustrating the processes of each unit included in the handwritten character correction apparatus 100.

First, an operation performed when a stroke information group (that is to be used as authentication information) and handwriting information are stored (registered) in the character information database 150 of the handwritten character correction apparatus 100 is described.

In the handwritten character correction apparatus 100 according to an embodiment of the present invention, the application execution unit 110 receives input of a handwritten stroke from a user (Step S1001). Then, the application execution unit 110 obtains stroke information and a stroke image of the input stroke and sends the stroke image to the handwritten character correction process unit 120 (Step S1002). The handwritten character correction process unit 120 attaches a label to the input stroke image (Step S1003). In this embodiment, the number of times in which the application execution unit 110 and the handwritten character correction process unit 120 perform the processes of Steps S1001 and S1002 is equivalent to the number of strokes that are input.

When the input of stroke images is completed by the application execution unit 110, the handwritten character correction unit 120 stores a handwriting image constituted by the obtained stroke images, a label-attached image, and an intersection area list in the storage unit 140 (Step S1004). More specifically, the handwritten character correction unit 120 stores a handwriting image, a label-attached image, and an intersection area list ID in the character image database 150 of the storage unit 140. Further, the handwritten character correction unit 120 associates the intersection area list with the character string ID and stores the associated information in the intersection area list database 160.

Further, when the input of strokes by the application execution unit 110 is completed, the application execution unit 110 sends the stroke information group to the recognition process unit 130 (Step S1005). The recognition process unit 130 performs a recognition process based on the obtained stroke information group (Step S1006). Then, the recognition process unit 130 sends the recognized character string from handwriting input and the circumscribing frame coordinates of the circumscribing frames of each character included in the recognized character string to the application execution unit 110 (Step S1007).

Then, the application execution unit 110 stores the obtained stroke information group, the recognized character string from the handwriting input, and the circumscribing frame coordinates in the storage unit 140 of the character information database 150 (Step S1008). It is to be noted that the application execution unit 110 of this embodiment may associate the character string ID with the recognized character string from the handwriting input and the values of the other data items of the character information database 150. Further, when the application execution unit 110 obtains the recognized character string from the handwriting input, the application execution unit 110 displays the obtained recognized character string (Step S1009).

By performing the processes described above, the storage (registration) of the stroke information group and the handwriting image can be performed by the handwritten character correction apparatus 100.

Next, an operation of the handwritten character correction apparatus 100 is described in a case where the handwritten character correction apparatus 100 receives an instruction to correct a recognized character string from handwriting input.

In a case where a target correction character is identified in a displayed recognized character string from handwriting input and the input of a handwritten stroke of a target replacement character is received (Step S1010), the application execution unit 110 obtains stroke information and a stroke image corresponding to the input stroke and sends the obtained stroke image to the handwritten character correction process unit 120 (Step S1011). Then, the handwritten character correction process unit 120 attaches a label to the stroke image received from the application execution unit 110 (Step S1012). In this embodiment, the number of times in which the application execution unit 110 and the handwritten character correction process unit 120 perform the processes of Steps S1010 and S1012 is equivalent to the number of strokes that are input.

Accordingly, by attaching a label to a stroke image including the stroke image of the target replacement character, the below-described correction process can be performed even in a case where, for example, the target replacement character is desired to be further corrected.

Because the processes performed in Steps S1013 to S1015 are the same as the processes of Steps S1005 to S1007, explanation of the processes performed in Steps S1013 to S1015 is omitted.

After Step S1015, the application execution unit 110 sends the recognized character from the handwriting input and the circumscribing frame coordinates obtained in Step S1015 to the handwritten character correction process unit 120 (Step S1016).

Then, the handwritten character correction process unit 120 corrects the character information corresponding to the recognized character string instructed to be corrected by using the label-attached stroke image of Step S1012, the target replacement character, and the circumscribing frame coordinates of the target replacement character (Step S1017). Then, the handwritten character correction apparatus 100 reflects the change of the character information to the character information database 150 according to the above-described correction process (Step S1018).

Then, the handwritten character correction process unit 120 generates a corrected character string by replacing the target correction character of the recognized character string with the target replacement character and sends the corrected character string to the application execution unit 110 (Step S1019).

The application execution unit 110 displays the obtained corrected character string (Step S1020). Alternatively, the process of generating the corrected character string by replacing the target correction character with the target replacement character may be performed by the application execution unit 110 instead of the handwritten character correction process unit 120.

By performing the processes described above, the handwritten character correction apparatus 100 can perform a correction process on the recognized character string instructed to be corrected.

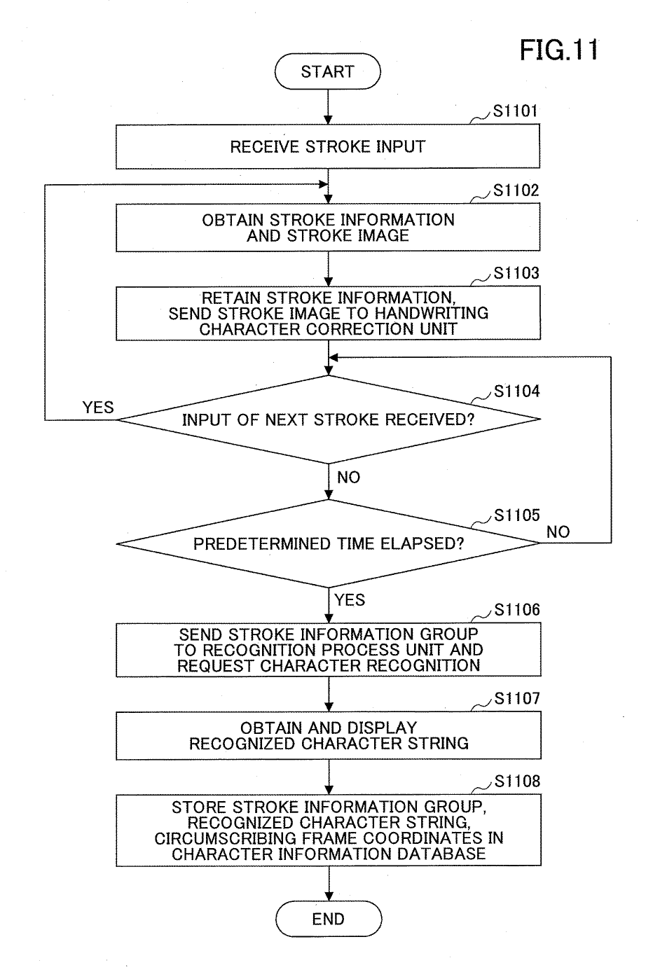

Next, an operation performed by each of the units included in the handwritten character correction apparatus 100 is described. FIG. 11 is a flowchart illustrating an operation performed by the application execution unit 110.

When input of a handwritten stroke is received (Step S1101), the application execution unit 110 obtains stroke information and a stroke image corresponding to the input stroke (Step S1102). Then, the application execution unit 110 retains the stroke information and sends the stroke image to the handwritten character correction process unit 120 (Step S1103).

Then, the application execution unit 110 determines whether input of another handwritten stroke is received (Step S1104). In a case where the application execution unit 110 determines that another input of a handwritten stroke is received in Step S1104, the application execution unit 110 returns to the process of Step S1102.

In a case where the application execution unit 110 determines that another input of a handwritten stroke is not received in Step S1104, the application execution unit 110 determines whether a predetermined time has elapsed (Step S1105).

In a case where the application execution unit 110 determines that the predetermined time has not elapsed in Step S1105, the application execution unit 110 returns to the process of Step S1104.

In a case where application execution unit 110 determines that the predetermined time has elapsed in Step S1105, the application execution unit 110 sends the retained stroke information group to the recognition process unit 130 (Step S1106).

Then, the application execution unit 110 receives the character string according to the recognition result of the recognition process unit 130 and displays the recognized character string from the handwriting input (Step S1107). Along with the receiving the recognized character string from the handwriting input, the application execution unit 110 also receives the circumscribing frame coordinates of each character included in the recognized character string.

Then, the application execution unit 110 stores the stroke information group, the recognized character string from the handwriting input, and the circumscribing frame coordinates of each character included in the recognized character string in the storage unit 140 of the character information database 150 (Step S1108). In Step S1108, the application execution unit 110 may assign a character string ID to the recognized character string from the handwriting input and store the character string ID in the character information database 150 in association with the stroke information group, the recognized character string from the handwriting input, and the circumscribing frame coordinates of each character of the recognized character string.

Next, an operation of the handwritten character correction process unit 120 is described. The handwritten character correction process unit 120 performs a process of registering (storing) a handwriting image and stroke information in the character information database 150 and a process of correcting the character information in response to an instruction to correct a recognized character string from handwriting input.

More specifically, the handwritten character correction process unit 120 performs a process of generating a label-attached image by attaching a label to a stroke image when registering a handwriting image and stroke information and a process of generating an intersection area list depending on whether there is an intersecting area between the stroke images.

Further, in a case where correction of a recognized character string from handwriting input is instructed, the handwritten character correction process unit 120 erases a stroke image constituting a target correction character, obtains a stroke image of a target replacement character, and updates the character information database 150. Further, the handwritten character correction process unit 120 generates a corrected character string by replacing the target correction character of the recognized character string with the target replacement character and sends the corrected character string to the application execution unit 110.

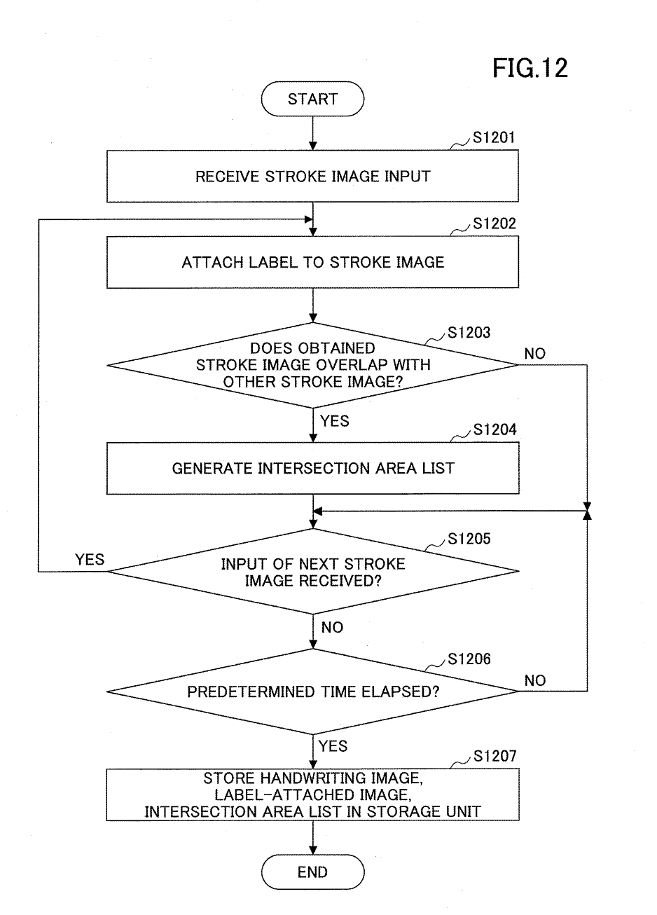

Next, the process of registering a handwriting image and stroke information in the character information database 150 is described with reference to FIG. 12.

FIG. 12 is a first flowchart illustrating an operation performed by the handwritten character correction process unit 120 according to an embodiment of the present invention. The operation of FIG. 12 illustrates the details of the processes performed in Step S1002 to S1004 of FIG. 10. Further, the processes performed in Step S1201 to S1206 of FIG. 12 correspond to the details of the processes performed in Step S1011 and S1012 of FIG. 10.

The handwritten character correction process unit 120 of this embodiment obtains a stroke image from the application execution unit 110 by way of the stroke obtaining unit 121 (Step S1201).

Then, the handwritten character correction process unit 120 attaches a label to the stroke image by way of the label-attached image generation unit 122 (Step S1202). More specifically, the label-attached image generation unit 122 attaches a label to a stroke image in which each label indicates the order in which the stroke image is obtained from the stroke obtaining unit 121 once the input of stroke images is started.

For example, the label of the first stroke image obtained by the stroke obtaining unit 121 is “1”. The label of the second stroke image obtained by the stroke obtaining unit 121 is “2”. That is, in this embodiment the label attached to a stroke image is a value indicating the order of the stroke that is input (e.g., first stroke, second stroke, . . . ). Further, in this embodiment, a label is attached to a stroke image by assuming a gradation value of the stroke image to be the value of the label. The process of attaching the label is described in further detail below.

Then, the handwritten character correction process unit 120 determines whether an already-obtained stroke image overlaps with the stroke image obtained in Step S1202 byway of the intersection determination unit 123 (Step S1203). Alternatively, the intersection determination unit 123 may determine whether the stroke images overlap based on the stroke information retained by the application execution unit 110.

In the process of registering the handwriting image and the stroke information according to this embodiment, the handwritten character correction process unit 120 does not receive the stroke information. The handwritten character correction process unit 120 may, however, receive a stroke image and stroke information from the application execution unit 110, for example, in Step S1201.

In a case where the handwritten character correction process unit 120 determines that the stroke images overlap in Step S1203, the handwritten character correction process unit 120 generates an intersection area list by way of the intersection area list generation unit 124 (Step S1204) and proceeds to the below-described process of Step S1205.

In a case where the handwritten character correction process unit 120 determines that the stroke images do not overlap in Step S1203, the handwritten character correction process unit 120 determines whether input of a subsequent stroke image is received (Step S1205). In a case where the handwritten character correction process unit 120 determines that input of the subsequent stroke image is received in Step S1205, the handwritten character correction process unit 120 returns to the process of Step S1202.

In a case where the handwritten character correction process unit 120 determines that input of the subsequent stroke image is not received in Step S1205, the handwritten character correction process unit 120 determines whether a predetermined time has elapsed (Step S1206).

In a case where the predetermined time has not elapsed in Step S1206, the handwritten character correction process unit 120 returns to the process of Step S1205.

In a case where the predetermined time has elapsed in Step S1206, the handwritten character correction process unit 120 stores the handwriting image, the label-attached image, and the intersection area list in the storage unit 140 (Step S1207).

More specifically, the handwritten character correction process unit 120 stores an image including a stroke image as the handwriting image in the character information database 150. Further, the handwritten character correction process unit 120 stores an image including a label-attached stroke image as the label-attached image in the character information database 150.

Further, the handwritten character correction process unit 120 attaches an intersection area list ID to the intersection area list, associates the intersection list ID to the handwriting image and the label-attached image, and stores the associated data in the character information database 150. The intersection area list ID, the handwriting image, the label-attached image are associated with the character string ID, the recognized character string from the handwriting input, the stroke information group, and the circumscribing frame coordinates that are stored by the application execution unit 110.

Further, the handwritten character correction process unit 120 associates the intersection area list ID and the intersection area list and stores the associated data in the storage unit 140 of the intersection area list database 160.

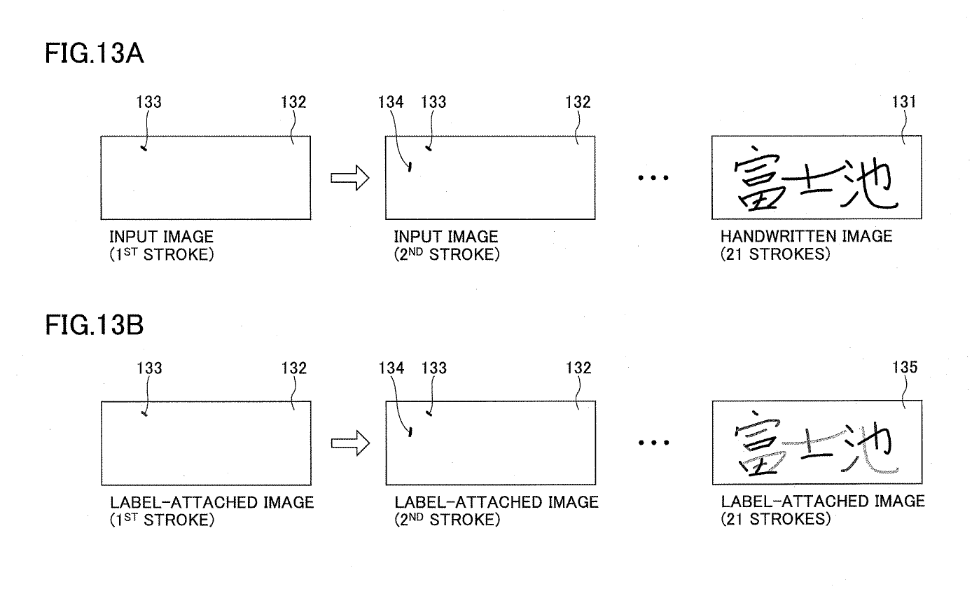

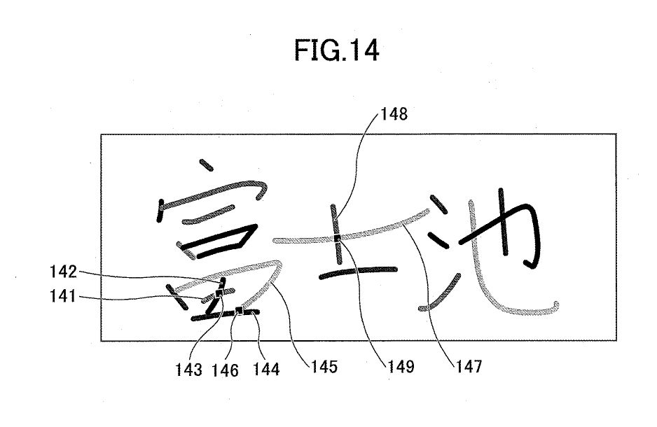

Next, a label-attaching process performed by the label-attached image generation unit 122 is described with reference to FIGS. 13A and 13B. Note that the images depicted in FIGS. 13 and 14 are monochrome images.

FIGS. 13A and 13B are schematic diagrams illustrating a label attaching process by the label-attached image generation unit 122. More specifically, FIG. 13A illustrates an example in which no label is attached to a handwriting image whereas FIG. 13B illustrates an example in which a label is attached to a handwriting image.

In a case where the handwriting image 131 is an 8 bit image and the gradation value of a background area 132 is 255 in FIG. 13A, the gradation value of the area of a stroke image is a predetermined value other than 255.

For example, an area 133 of a stroke image corresponding to a stroke that is input first (i.e., first stroke image) is to have a gradation value other than the gradation value of the background area 132. Further, an area 134 of a stroke image corresponding to a stroke that is input second (i.e., second stroke image) is assumed to have a gradation that is the same as the gradation value of the area 133 of the first stroke image.

Accordingly, in a case where a total of 21 strokes are input from start to finish of inputting a handwritten character(s), the handwriting image 131 is displayed in a manner in which the areas corresponding to all stroke images are displayed with the same gradation value as illustrated in FIG. 13A.

On the other hand, the label-attached image generation unit 122 sets the gradation value of the pixel(s) of the area 133 of the first stroke image to be a number corresponding to the input order of the stroke (in this example, “1” indicating the first stroke) as illustrated in FIG. 13B. Thus, a gradation value “1” is used as the label of the stroke image corresponding to the first stroke.

Similarly, the label-attached image generation unit 122 sets the gradation value of the pixel(s) of the area 134 of the second stroke image to be a number corresponding to the input order of the stroke (in this example, “2” indicating the second stroke) as illustrated in FIG. 13B. Thus, a gradation value “2” is used as the label of the stroke image corresponding to the second stroke.

Accordingly, whenever stroke images are input, the label-attached image generation unit 122 assigns the input order of the stroke images (counted from the start of the input) to be the gradation values of the pixel(s) of the area of the stroke images. Thus, the gradation values are used as labels of the stroke images. Hence, the label-attached image 135 (right side of FIG. 13B) is displayed as an image including 21 stroke images each of which having different gradation values.

The label-attached image 135 of this embodiment may be stored in the form of, for example, a bitmap format image in the character information database 150.

According to the above-described embodiment of the present invention, a value indicating the input stroke order of a stroke image is assigned to be the gradation value of a pixel(s) within the area of the stroke image. Further, the gradation value is used as a label for identifying the stroke image. Therefore, the input stroke order of the stroke image corresponding to the label can be determined by referring to the label (gradation value) of the stroke image of the label-attached image.

Although the stroke images constituting a handwriting image are displayed with the same gradation value in the above-described embodiment, the stroke images constituting a handwriting image may be displayed to have shades corresponding to, for example, writing pressure.

Next, the intersection area list is described.

In a case where a stroke image is input, the handwritten character correction process unit 120, byway of the intersection determination unit 123, determines whether a label-attached stroke image generated by the label-attached image generation unit 122 overlaps with another stroke image. That is, the intersection determination unit 123 determines whether a label-attached stroke image intersects another label-attached stroke image.

When the intersection determination unit 123 determines that the label-attached stroke image overlaps with another label-attached stroke image, the intersection area list generation unit 124 generates an intersection area list that identifies the area at which the stroke images intersect. Note that the intersection area list is generated in association with each character string ID. Accordingly, the intersection area list and the associated character string ID are stored in the intersection area list database 160.

FIG. 14 is a schematic diagram illustrating the intersection of stroke images. In a case where a stroke image of the eleventh stroke is input, the intersection determination unit 123 determines that the input stroke image of the eleventh stroke intersects with an input stroke image of the tenth stroke as illustrated FIG. 14.

More specifically, the intersection determination unit 123 determines that a part of a linear area 141 representing the stroke image of the eleventh stroke overlaps with a linear image 142 representing the stroke image of the tenth stroke.

When two stroke images are determined to overlap with each other, the intersection area list generation unit 124 obtains the coordinates of an area 143 at which the linear area 141 and the linear area 142. The coordinates obtained by the intersection area list generation unit 124 serve as the representative coordinates of the overlapping area 143. For example, the intersection area list generation unit 124 obtains the representative coordinates, that is, the matching coordinates between the coordinates included in the stroke information of the stroke image of the eleventh stroke and the coordinates included in the stroke information of the stroke image of the tenth stroke. In the following description, an area in which the areas of multiple stroke images overlap is referred to as “intersection area”.

Further, the intersection area list generation unit 124 obtains the value “11” of the label of the stroke image corresponding to the linear area 141 and the value “10” of the label of the stroke image corresponding to the area 142 and calculates the total of the values of the two labels. Then, the intersection area list generation unit 124 associates the calculated total value of the labels, the representative coordinates, and the labels of the overlapped stroke images. Then, the intersection area list generation unit 124 stores the associated total value of the labels, the representative coordinates, and the labels of the overlapped stroke images in the intersection area list.

Similarly, the intersection determination unit 123 determines that the stroke image of the twelfth input stroke overlaps with the stroke image of the ninth input stroke. Accordingly, the intersection area list generation unit 124 obtains the representative coordinates of an overlapping area 146 at which a linear area 144 representing the stroke image of the twelfth stroke and a linear area 145 representing the stroke image of the ninth stroke overlap. Then, the intersection area list generation unit 124 stores the representative coordinates and associated data in the intersection area list as described above.

Further, the intersection determination unit 123 determines that a linear area 147 representing the stroke image of the fourteenth input stroke overlaps with a linear area 148 representing the stroke image of the thirteenth input stroke. Accordingly, the intersection area list generation unit 124 obtains the representative coordinates of an overlapping area 149 at which the linear area 147 and the linear area 148 overlap. Then, the intersection area list generation unit 124 stores the representative coordinates and associated data in the intersection area list as described above.

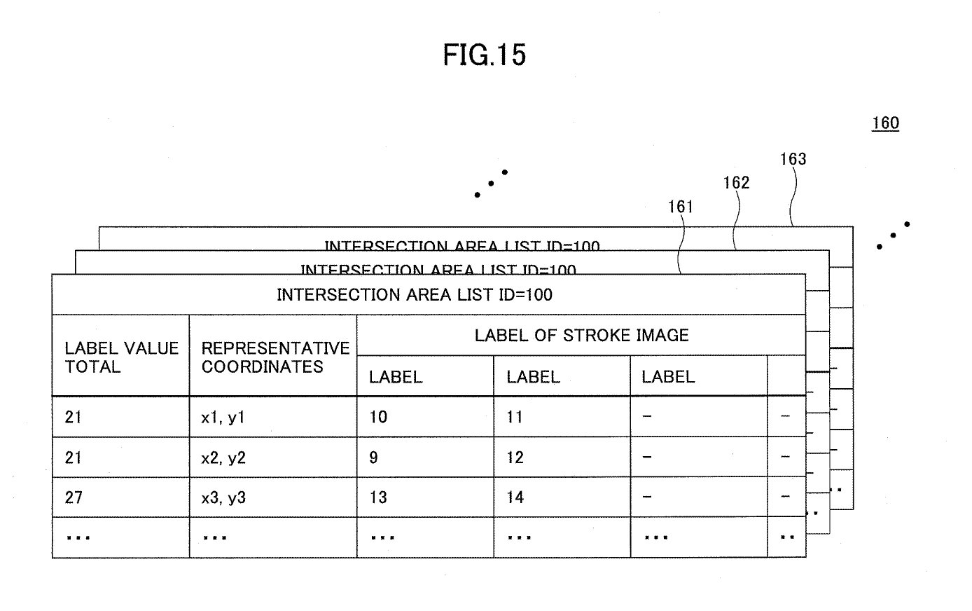

Next, the intersection area list database 160 according to an embodiment of the present invention is described with reference to FIG. 15. FIG. 15 is a schematic diagram illustrating a configuration of the intersection area list database 160.

The intersection area list database 160 of this embodiment includes intersection area lists 161-163 that are generated in correspondence with each character string ID. Note that a given number of intersection area lists may be included in the intersection area list database 160.

The intersection area list 161 illustrated in FIG. 15 corresponds to the intersection area list ID “100” included in the character information associated with the character string ID “1” of the character information database 150 illustrated in FIG. 9.

The intersection area list 161 includes data items such as “label total”, “representative coordinates”, and “label of stroke image”. In the intersection area list 161, the data item “label value total” is associated with the other remaining data items. In the following description, the value of the data item “label value total” and the values of the other remaining data items of the intersection area list 161 are referred to as “intersection area information”.

The value of the data item “label value total” is a value indicating the total values of the labels of the stroke images corresponding to the linear areas that include a part of the intersection area. That is, the value of the data item “label value total” is the total of the values of the labels of the stroke images that overlap in the intersection area.

Note that, although the value of the data item “representative coordinates” is illustrated to include a single set of coordinates, multiple sets of coordinates may be included to be the values of the data item “representative coordinates”. For example, in a case of an intersection area that covers a large area, multiple sets of coordinates indicating the outline of the intersection area may be stored as the values of the data item “representative coordinates”.

The value of the data item “label of stroke image” indicates the value of the label of each stroke image having a part included in the intersection area. Therefore, the value of the data item “label of stroke image” may include the values of the labels of multiple stroke images. Further, the value of the data item “label value total” indicates the total of the values of the labels included in the data item. “label of stroke image”.

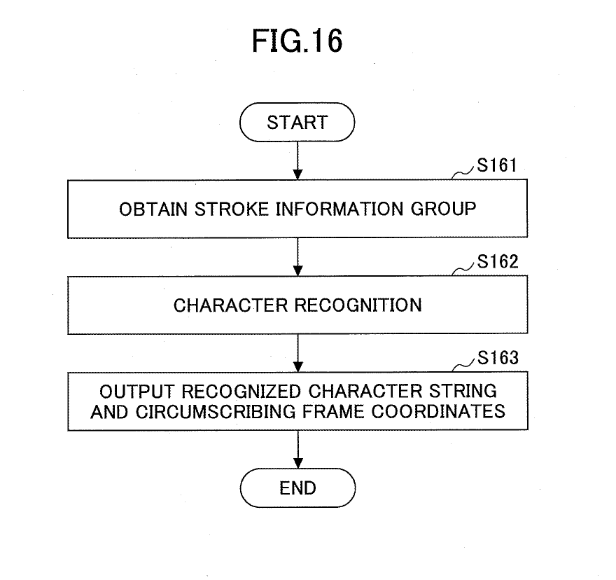

In the intersection area list 161 of FIG. 16, the intersection area information having a label value total of “21” includes the “representative coordinates” indicated as (x1, y1) and the “label of stroke image” indicated as “10” and “11”. Accordingly, the intersection area information having a label value total of “21” indicates that the stroke image of the tenth input stroke and the stroke image of the eleventh input stroke overlap in the area having the coordinates (x1, y1).

Further, in the intersection area list 161, another intersection area information having a label value total of “21” indicates that the stroke image of the ninth input stroke and the stroke image of the twelfth input stroke overlap in the area having the coordinates (x2, y2). Accordingly, even in a case where the label value total of one intersection area information is the same as the label value total of another intersection area information, the intersection area of one intersection area information is different from the intersection area of the other intersection area information because the “label value total” is associated with the “representative coordinates”.

Further, in the intersection area list 161, the intersection area information having a label value total of “27” indicates that the stroke image of the thirteenth input stroke and the stroke image of the fourteenth input stroke overlap in the area having the coordinates (x3, y3).

Next, an operation of the recognition process unit 130 according to an embodiment of the present invention is described with reference to FIG. 16. FIG. 16 is a flowchart illustrating an operation of the recognition process unit 130 according to an embodiment of the present invention. The operation of FIG. 16 illustrates the details of the processes performed in Step S1006 and Step S1014 of FIG. 10.

First, the recognition process unit 130 of this embodiment obtains a stroke information group from the application execution unit 110 (Step S161). Then, the recognition process unit 130 performs character recognition based on the obtained stroke information group. Thereby, the recognition process unit 130 obtains the recognized character string from the handwriting input and the circumscribing frame coordinates of each character included in the recognized character string (Step S162). Note that the circumscribing frame coordinates of this embodiment include information indicating the order of the circumscribed frame in the recognized character from the handwriting input.

Then, the recognition process unit 130 sends the recognized character string from the handwriting input and the circumscribing frame coordinates of each character to the application execution unit 110 (Step S163).

When the application execution unit 110 receives the recognized character string from the handwriting input, the application execution unit 110 instructs the recognized character string to be displayed in the recognition result display column 23 of the screen of the handwritten character correction apparatus 100 (see, for example, FIG. 2).

Next, an operation of the handwritten correction process unit 120 upon receiving an instruction to correct a recognized character string from handwriting input is described.

In a case where a user's selection of a character in the recognized character string displayed in the recognition result display column 23 is received, the application execution unit 110 identifies the selected character as the target correction character.

Then, the recognition process unit 130 recognizes a character from the stroke(s) input to the handwriting input column 22 after the selection of the target correction character. Then, the application execution unit 110 identifies the recognized character to be the target replacement character. Then, the application execution unit 110 sends an instruction to correct the recognized character string to the handwritten character correction process unit 120. Along with the instruction, the application execution unit 110 also sends information indicating the position of the target correction character, the target replacement character, the stroke information group corresponding to the target replacement character, and the circumscribing frame coordinates to the handwritten character correction process unit 120. Note that the information indicating the position of the target correction character may include information indicating the order of the selected character in the recognized character string from the handwriting input.

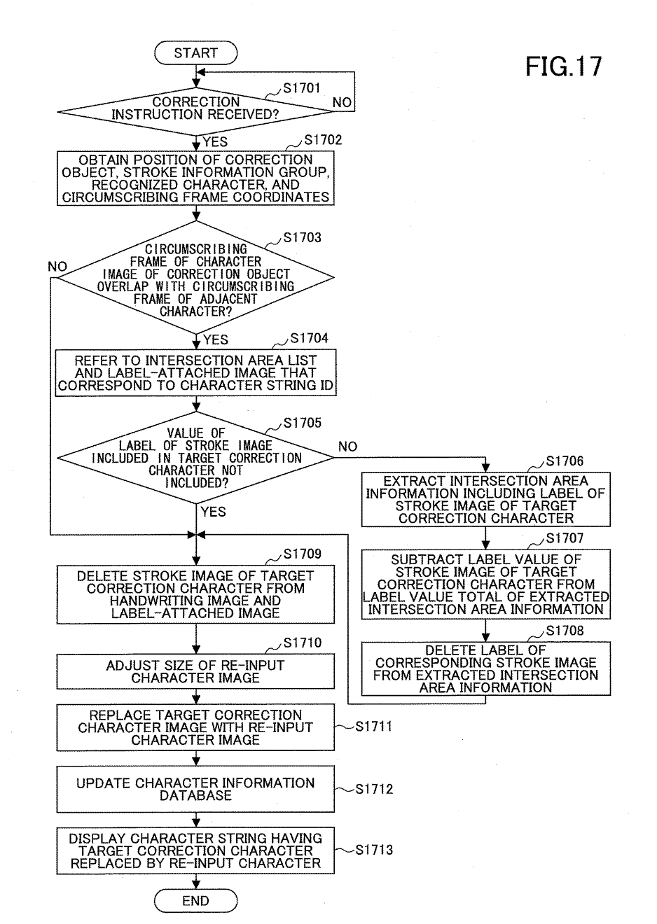

Next, an operation of the handwriting character correction process unit 120 upon receiving an instruction to correct a recognized character string from handwriting input is described with reference to FIG. 17.

FIG. 17 is a second flowchart illustrating an operation performed by the handwritten character correction process unit 120 according to an embodiment of the present invention. The operation of FIG. 17 illustrates the details of the processes performed in Step S1016 to Step S1019 of FIG. 10.

The handwritten character correction process unit 120 of this embodiment determines whether an instruction to correct a recognized character string from handwriting input is received from the application execution unit 110 (Step S1701). In a case where the handwritten character correction process unit 120 determines that the instruction from the application execution unit 110 is not received in Step S1701, the handwritten character correction process unit 120 waits to receive an instruction correct a character string recognized from handwriting input.

In a case where the handwritten character correction process unit 120 determines that the instruction from the application execution unit 110 is received in Step S1701, the handwritten character correction process unit 120, by way of the stroke image erasing unit 125, obtains information indicating the position of the target correction character, the target replacement character, and the stroke information group corresponding to the target replacement character, and the circumscribing frame coordinates from the application execution unit 110 (Step S1702).

Then, the handwritten character correction process unit 120, by way of the stroke image erasing unit 125, refers to the character information database 150 and determines whether the circumscribing frame of the target correction character overlaps with the area of the circumscribing frame of a character adjacent to or neighboring the target correction character (hereinafter referred to as “adjacent character”) (Step S1703).

In a case where the circumscribing frame of the target correction character is not determined to overlap the circumscribing frame of the adjacent character in Step S1703, the stroke image erasing unit 125 proceeds to the below-described process of Step S1709.

In a case where the circumscribing frame of the target correction character is determined to overlap the circumscribing frame of the adjacent character in Step S1703, the stroke image erasing unit 125 refers to the label-attached image associated with the character string ID corresponding to the recognized character string of the character information database 150 (Step S1704). In addition, the stroke image erasing unit 125 also refers to the intersection area list associated with the character string ID (same character string ID referred in this Step S1704) of the intersection area list database 160 (Step S1704).

Then, the stroke image erasing unit 125 determines whether the values of the data item “label of stroke image” of the intersection area list contain the value of the label of the stroke image included in the target correction character (Step S1705).

In a case where the stroke image erasing unit 125 determines that the values of the data item “label of stroke image” of the intersection area list do not contain the value of the label of the stroke image included in the target correction character in Step S1705, the stroke image erasing unit 125 proceeds to the below-described process of Step S1709.

In a case where the stroke image erasing unit 125 determines that the values of the data item “label of stroke image” of the intersection area list contain the value of the label of the stroke image included in the target correction character in Step S1705, the handwritten character correction process unit 120, byway of the database update unit 128, updates the intersection area list referred in Step S1704. The following processes of Step S1706 to S1708 are the processes for updating the intersection area list.

The database update unit 128 extracts the intersection area information from the intersection area list (Step S1706). The extracted intersection area information is to be the value of the label of the stroke image of the target correction character that is contained in the values of the data item “label of stroke image” of the intersection area list.

Then, the database update unit 128 subtracts the value of the label of the stroke image of the target correction character from the label value total of the extracted intersection area information (Step S1707). Then, the database update unit 128 deletes the value of the label of the stroke image of the target correction character from the value of the data item “label of stroke image” of the extracted intersection area information.

Then, the handwritten character correction process unit 120, by way of the stroke image erasing unit 125, erases the stroke image of the target correction character from the label-attached image associated with the character string ID corresponding to the recognized character string (Step S1709).

Then, the handwritten character correction process unit 120 adjusts the size of the circumscribing frame of the character recognized in Step S1702 to the size of the circumscribing frame of the target correction character (Step S1710). That is, the circumscribing frame-size changing unit 126 adjusts the size of the image of the target replacement character.

Then, the handwritten character correction process unit 120, by way of the character image replacement unit 127, replaces the image of the target correction character with the image of the target replacement character (Step S1711). The character image replacement unit 127 performs the replacement by inserting the size-adjusted image of Step S1710 into a position from which the image of the target correction character is erased

Then, the handwritten character correction process unit 120, by way of the database update unit 128, updates the character information database 150 and the intersection area list database 160 (Step 1712). More specifically, the database update unit 128 updates the character information and the intersection area list that correspond to the character string ID in the character information database 150.

Then, the handwritten character correction process unit 120 sends a corrected character string in which the target correction character of the recognized character string is replaced by the target replacement character (Step S1713).

The application execution unit 110 displays the corrected character string in the recognition result display column when receiving the corrected character string from the handwritten character correction unit 120 (see, for example, Step S1020 of FIG. 10).

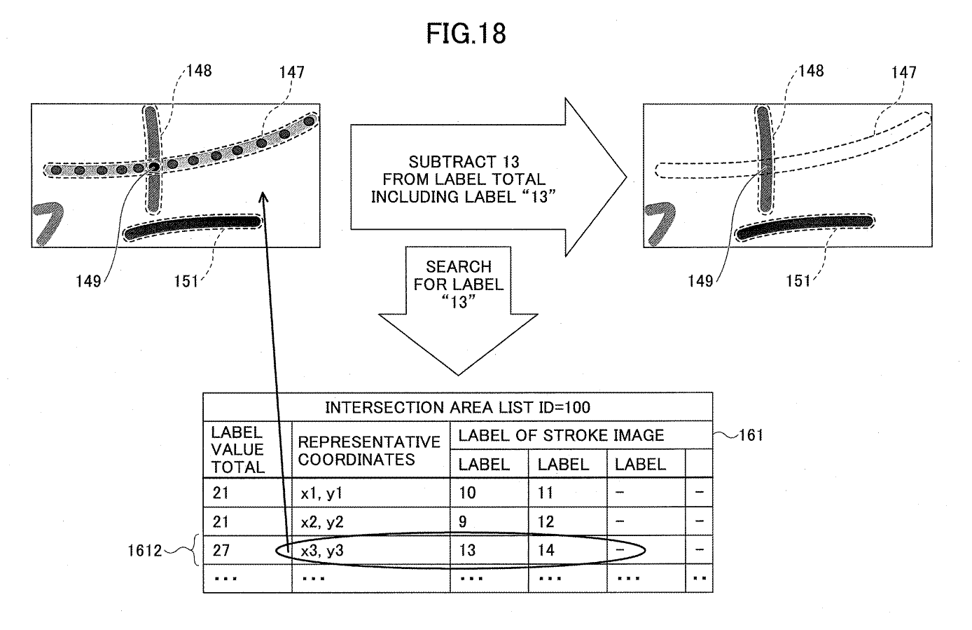

Next, the process of erasing a stroke image and the process of updating an intersection area list are described in further detail. FIG. 18 is a schematic diagram illustrating the updating process of the intersection area list. The processes illustrated in FIG. 18 correspond to the processes of Steps S1706 to Step S1708 (FIG. 17) performed by the database update unit 128.

In the example illustrated in FIG. 18, the target correction character “ [symbol] ” includes a stroke image 147 of the thirteenth input stroke, a stroke image 148 of the fourteenth input stroke, and a stroke image 149 of the fifteenth input stroke.

Accordingly, the stroke image erasing unit 125 extracts intersection area information having the label “13” of the stroke image 147 contained in the value of the “label of stroke image” of the intersection area list.

In the intersection area list 161 of FIG. 18, the label “13” is included in the intersection area information 1612 having the label value total “27”. Accordingly, the stroke image erasing unit 125 extracts the intersection area information 1612 having the label value total “13”.

Then, the stroke image erasing unit 125 subtracts the value “13” of the label of the stroke image 147 from the label value total “27”. Further, the stroke image erasing unit 125 erases the value “13” of the label of the stroke image 147 from the data item “label of stroke image”.

Accordingly, the intersection area list 161 is updated by the above-described processes performed by the database update unit 128.

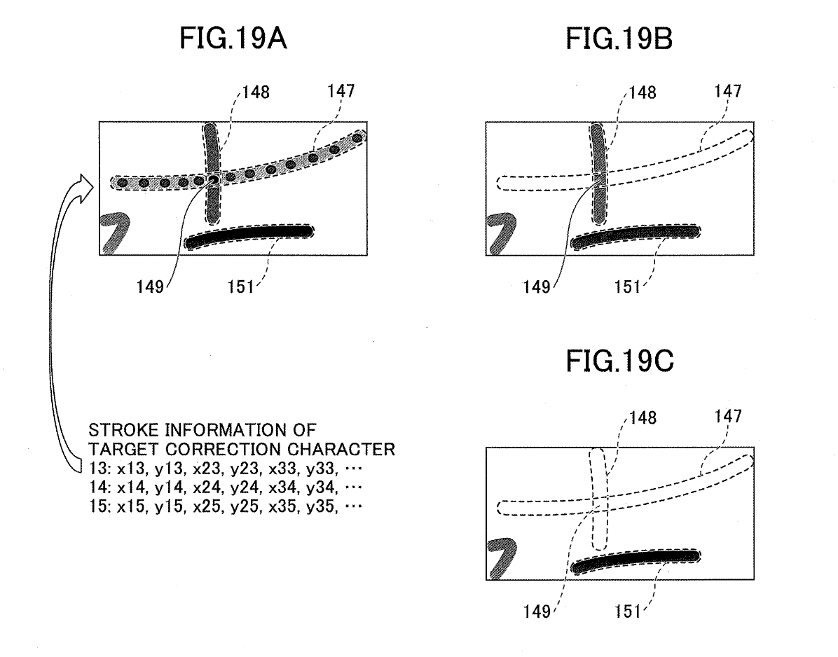

Next, the process of erasing a stroke image is described in further detail with reference to FIG. 19. FIGS. 19A-19C are schematic diagrams illustrating the process of erasing a stroke image. FIG. 19A depicts a process of detecting a stroke image that is to be erased. FIG. 19B depicts a process of erasing a stroke image of the thirteenth input stroke. FIG. 19C depicts a process of erasing a stroke image of the fourteenth input stroke.

The processes illustrated in FIGS. 19A-19C correspond to the process performed in Step S1709 (FIG. 17) by the stroke image erasing unit 125.

The stroke image erasing unit 125 of this embodiment refers to the character information database 150 and detects a linear area of a label-attached image corresponding to a stroke image of a target correction character based on the coordinates indicated in the stroke information of the target correction character. Then, the stroke image erasing unit 125 deletes the stroke image by subtracting the value of the stroke image corresponding to the detected linear area from the gradation value of the pixel in the detected linear area.

As illustrated in FIG. 19A, the stroke image deleting unit 125 obtains stroke information of the thirteenth input stroke from the stroke information corresponding to the recognized character string “ [symbol] [symbol] ” of the character information database 150. Then, the stroke image deleting unit 125 detects the linear area of the stroke image 147 of the label-attached image from the coordinates included in the obtained stroke information of the thirteenth input stroke.

Further, the stroke image erasing unit 125 subtracts the value “13” of the label of the stroke image 147 from the gradation value of the pixel in the detected linear area of the stroke image 147.

In the label-attached image, the stroke image is depicted as a gradation value of the stroke image that indicates the order in which the stroke image is input.

Accordingly, the gradation value of the pixel included in the linear area corresponding to the stroke image 147 of the thirteenth input stroke becomes zero by subtracting the value of the label from the gradation value of the pixel in the linear area of the stroke image 147. Thus, the stroke image 147 is erased as illustrated in FIG. 19B.

Note that the erasing of the stroke image (gradation value=0) of this embodiment is performed by changing the gradation value of the pixel in the linear area of the stroke image to become the same value as the gradation value of the background area of the label-attached image.

In the state illustrated in FIG. 19A, the stroke image 147 and the stroke image 148 intersect in the intersection area 149. The intersection area 149 is an area having the representative coordinates (x3, y3) of the intersection area information 148.

The gradation value of the intersection area 149 is the total value of the gradation value of the linear area 147 and the gradation value of the linear area 148. Accordingly, the gradation value of the intersection area 149 becomes equal to the gradation value of the linear area 148 by subtracting the gradation value of the linear area 147.

That is, the gradation value of the intersection area 149 becomes a value “14” by subtracting the value “13” of the label of the stroke image 147 from the label value total “27” of the intersection area information 162. The value “14” is the gradation value of the stroke image 148 that overlapped with the stroke image 147. The stroke image 148 in the intersection area 149 remains the same.

Accordingly, the stroke image erasing unit 125 of this embodiment erases a stroke image by subtracting the gradation value of the linear area of the stroke image. Thus, with the above-described embodiment, the stroke image that is to be erased can be distinguished in the intersection area where stroke images overlap. Further, the stroke image that is not to be erased can remain in the intersection area.

With the above-described embodiment, a label attaching process is performed on each stroke image when a stroke is input. Accordingly, each stroke image can be distinguished even in a case where, for example, two stroke images are input to become connected state.

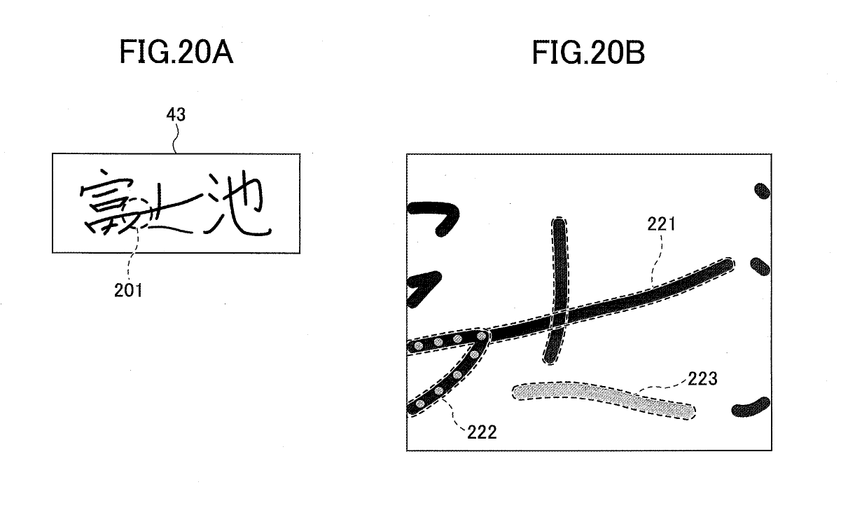

FIGS. 20A and 20B are schematic diagrams illustrating the effects of the label attaching process. FIG. 20A depicts an example of a handwriting image. FIG. 20B depicts an enlarged view of a portion of the handwriting image of FIG. 20A.

In this embodiment, each stroke image can be distinguished even in a case where multiple strokes overlap with each other as illustrated in the area 201 of FIGS. 20A and 20B.

As illustrated in FIGS. 20A and 20B, a stroke image 221 and a stroke image 222 partly overlap in an area 201.

In a case of performing a label attaching process according to this embodiment, an area where the stroke image 221 and the stroke image 222 overlap is registered in the intersection area list. Thereby, the stroke image 221 and the stroke image 222 can be distinguished from each other.

Thus, according to an embodiment of the present invention, even in a case where a part of a stroke image of a target correction character is connected to another stroke image of a character adjacent to the target correction character, only the part of the image of the target correction character can be erased without affecting the image of the adjacent character.

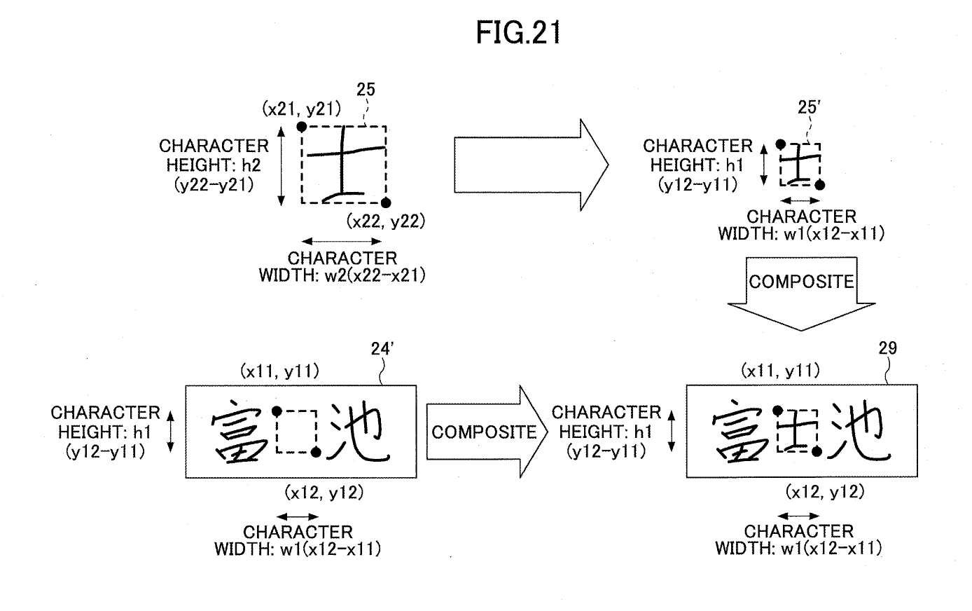

Next, a process performed by the circumscribing frame-size changing unit 126 is described. FIG. 21 is a schematic diagram illustrating the process performed by the circumscribing frame-size changing unit according to an embodiment of the present invention. FIG. 21 depicts the process performed by the circumscribing frame-size changing unit 126 in Step S1710 and the process performed by the character image replacement unit 127 in Step S1711 (see FIG. 17).

The circumscribing frame-size changing unit 126 of this embodiment obtains the circumscribing frame coordinates of the target replacement character. In FIG. 21, the circumscribing frame coordinates of the target replacement character are assumed to be (x21, y21) and (x22, y22).

Then, the circumscribing frame-size changing unit 126 obtains the height h2 and width w2 of the circumscribing frame of the label-attached image 25 of the target replacement character. The height of the circumscribing frame (height of the target replacement character) h2 is obtained by (y22−y21). The width of the circumscribing frame (width of the target replacement character) w2 is obtained by (x22−x21).

Then, the circumscribing frame-size changing unit 126 refers to the circumscribing frame coordinates of the character information database 150 and obtains the circumscribing frame coordinates of the target correction character. In FIG. 21, the circumscribing frame coordinates of the target correction character are assumed to be (x11, y11) and (x12, y12). Accordingly, the height h1 of the circumscribing frame of the target correction character is obtained by y12−y11. The width w1 of the circumscribing frame of the target correction character is obtained by x12−x11.

Then, the circumscribing frame-size changing unit 126 changes the height h2 and the width w2 of the circumscribing frame of the label-attached image 25 to the height h1 and the width w1.

In this embodiment, the character image replacement unit 127 composites a label-attached image 25′ with label-attached image 24′. The label-attached image 25′ is formed by replacing the height and the width of the target replacement character to match the height and width of the target correction character. The label-attached image 24′ is formed by erasing the image of the target correction character from the handwriting image 24.

When compositing the label-attached image 25′ with label-attached image 24′, the character image replacement unit 127 arranges the label-attached image 25′ and the label-attached image 24′, so that the circumscribing frame coordinates of the label-attached image 25′ match the circumscribing frame of the target correction character. That is, the label-attached image 25′ and the label-attached image 24′ are to be arranged, so that the circumscribing frame coordinates of the label-attached image 25′ become (x11, y11) and (x12, y12).

Accordingly, a label-attached image 29 can be generated by replacing the image of the target correction character with the image of the target replacement character as described above.

Thus, in the label-attached image 29 according to the above-described embodiment, the target correction character and the target replacement character having the same height as the height of the target correction character are arranged in the position of the target correction character. Therefore, with the above-described embodiment, a part of a label-attached image can be changed while maintaining the features of a handwritten character before being corrected.

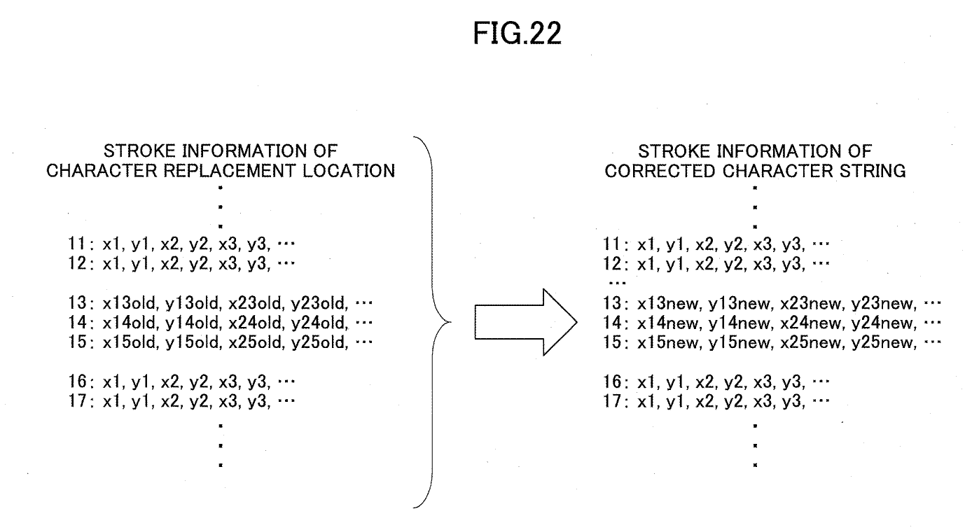

Next, a process of changing character information database 150 with the database update unit 128 is described. FIG. 22 is a schematic diagram illustrating a process performed by the database update unit 128.

FIG. 22 depicts the processes performed by the database update unit 128 in Step S1712 (see FIG. 17).

In a case where the image of the target replacement character is composited with the label-attached image from which the image of the target correction character is erased, the database update unit 128 of this embodiment converts the stroke information group corresponding to the target replacement character into a stroke information group corresponding to the image of the target replacement character after being composited. Then, the database update unit 128 replaces the stroke information group of the target correction character with the converted stroke information group.

The coordinates included in the stroke information group of the target correction character is converted into the stroke information group corresponding to the composited target replacement character by using Expression (1) below.

X coordinates: x_new=(x_old−x21)×w1/w2+x11

Y coordinates: y_new=(y_old−y21)×h1/h2+y11 [Expression (1)]

Note that “x_new” and “y_new” indicate the coordinates after the conversion of the stroke information group whereas “x_old” and “y_old” indicate the coordinates included in the stroke information group of the target correction character. Further, in Expression (1), “(x21, y21)” indicate the coordinates of the upper left edge of the circumscribing frame of the target replacement character whereas “x11, y11)” indicate the coordinates of the upper left edge of the circumscribing frame of the target correction character.

In a case where the character image replacement unit 127 generates the label-attached image 29 having the label-attached image 25′ composited with the label-attached image 24 (see FIG. 21), the database update unit 128 of this embodiment generates a duplicate of the label-attached image 29. Then, the database update unit 128 changes the gradation value of the stroke image included in the duplicate of the label-attached image 29 to a gradation value of the stroke image corresponding to the handwriting image. Thereby, a handwriting image without any labels corresponding to each stroke is obtained.

In other words, the database update unit 128 generates a handwriting image having the target correction character replaced by the target replacement character. Then, the database update unit 128 replaces the handwriting image, before being corrected, with a handwriting image generated from the duplicate of the label-attached image 29.

Hence, with above-described embodiment, a handwriting image can be replaced with a handwriting image to which a correction instructed by the user is reflected.

Therefore, among the character information containing a recognized character string from a handwriting input, only information pertaining to the target correction character can be changed when a target correction character is identified from the recognized character string obtained as a result of input stroke recognition.

That is, the part of the target correction character need only be corrected with respect to the data items constituting the character information including the recognized character string to be corrected, that is, the recognized character string from the handwriting input, the handwriting image, the circumscribing frame coordinates, the stroke information group, and the label-attached image.

Accordingly, in a case where a part of the characters of the character information is corrected, the character information can be corrected without affecting the information of the other characters.

Note that the handwriting input of the above-described embodiment is not limited to input by a user's finger. For example, the handwriting input may also be performed by using a rod-like writing device such as a stylus.

### Second Embodiment

Next, a second embodiment of the present invention is described. The second embodiment of the present invention differs from the first embodiment in that the handwritten character correction program 20 and the recognition program 30 are installed in a handwritten character correction program whereas the application 10 is installed in another apparatus. Therefore, in the second embodiment, like components and units are denoted with like reference numerals as the reference numerals of the first embodiment and are not further explained.

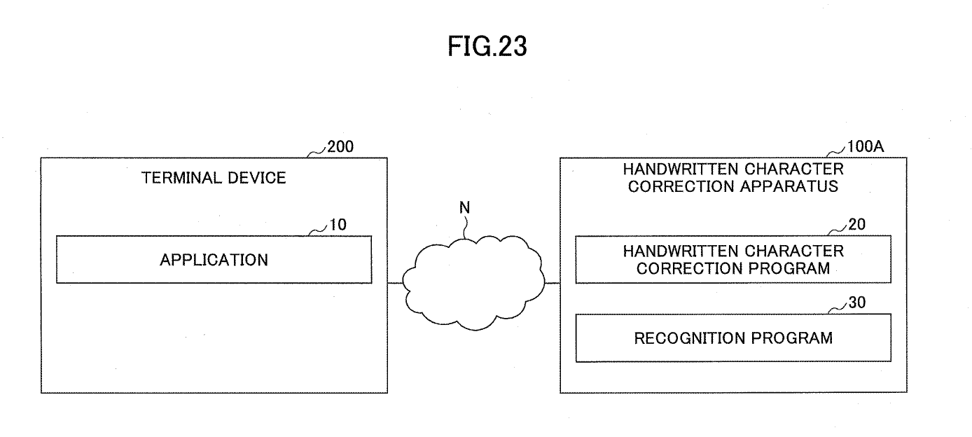

FIG. 23 is a schematic diagram illustrating the handwritten character correction apparatus 100A according to the second embodiment of the present invention. The handwritten character correction apparatus 100A includes the handwritten character correction program and the recognition program 30. Further, the handwritten character correction apparatus 100A is connected to a terminal device 200 via the network N. The terminal device 200 includes the application 10.

In other words, the handwritten character correction apparatus 100A includes the handwritten character correction process unit and the recognition process unit whereas the terminal device 200 includes the application execution unit.

The processes of each of the units included in the handwritten character correction apparatus 100A and the terminal device 200 are the same as the processes described with FIG. 10.

Therefore, the second embodiment can attain the same effects attained by the first embodiment. Further, in the second embodiment, the processes performed by the handwritten character correction program 20 and the processes performed by the recognition program 30 are performed by one or more apparatuses that is separate from the terminal device 200 that perform the processes of the application 10. Therefore, the workload of the terminal device 200 that execute the processes of the application 10 can be reduced.

### Third Embodiment

Next, the third embodiment according to an embodiment of the present invention is described. The third embodiment differs from the first embodiment in that the application 10 and the handwritten character correction program 20 are installed in the handwritten character correction apparatus whereas the recognition program is installed in another apparatus. Therefore, in the third embodiment, like components and units are denoted with like reference numerals as the reference numerals of the first embodiment and are not further explained.

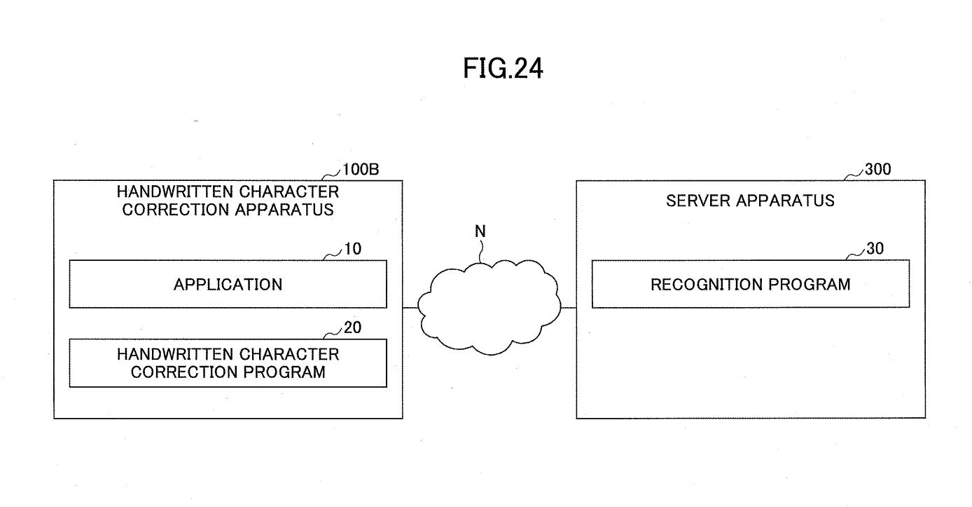

FIG. 24 is a schematic diagram illustrating the handwritten character correction apparatus 100B according to the third embodiment of the present invention. The handwritten character correction apparatus 100B includes the application 10 and the handwritten character correction program 20. Further, the handwritten character correction apparatus 100B is connected to a server apparatus 300 via the network N. The server apparatus 300 includes the recognition program 30.

In other words, the handwritten character correction apparatus 100B includes the application execution unit and the handwritten character correction process unit whereas the server apparatus 300 includes the recognition process unit.

The processes of each of the units included in the handwritten character correction apparatus 100B and the server apparatus 300 are the same as the processes described with FIG. 10.

Therefore, the third embodiment can attain the same effects attained by the first embodiment. Further, in the third embodiment, the recognition process is not performed by the handwritten character correction apparatus 100B but by the server apparatus 300. Therefore, the workload for the handwritten character correction apparatus 100B can be reduced.

Hence, with the above-described embodiments of the present invention, information of other characters can be prevented from being affected by the correction of a part of a handwritten character.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing therein a handwriting input recognition program that causes a computer to execute a process comprising:
correcting at least one of a character image of a target replacement character or stroke information of the target replacement character, in response to a designation of a specific character among a plurality of recognized characters from handwriting input and an input of the target replacement character that is to replace the specific character; and
updating at least one of a character image of the plurality of recognized characters or a stroke image of the plurality of recognized characters by utilizing at least a corrected one of the character image of the target replacement character or the stroke information of the target replacement character;
wherein the at least one of the character image of the target replacement character or the stroke information of the target replacement character is corrected based on coordinate information corresponding to the specific character; and
wherein the coordinate information is generated from at least one of the character image of the plurality of recognized characters or the stroke information of the plurality of recognized characters that are stored in a memory.

2. The non-transitory computer-readable recording medium as claimed in claim 1,
wherein the character image of the plurality of recognized characters and the character image of the target replacement character are generated in correspondence with each stroke image of a stroke that is input by hand,
wherein the character image of the plurality of recognized characters and the character image of the target replacement character are generated in response to the input of the stroke,
wherein the character image of the plurality of recognized characters and the character image of the target replacement character are generated from a label-attached image that has the stroke image associated with a label, and
wherein the label associated with the stroke image of the stroke includes a value indicating an order in which the stroke is input.

3. The non-transitory computer-readable recording medium as claimed in claim 2, wherein the value indicating the order in which the stroke is input is a gradation value of the stroke image.

4. The non-transitory computer-readable recording medium as claimed in claim 2,
wherein in a case where the plurality of stroke images overlap, a list is stored in the memory,
wherein the list includes a total of the values associated with each of the plurality of stroke images, coordinates indicating an overlapped area of the plurality of stroke images, and the values associated with each of the plurality of stroke images, and
wherein the total of the values associated with each of the plurality of stroke images, the coordinates indicating an overlapped area of the plurality of stroke images, and the values associated with each of the plurality of stroke images are associated with each other in the list.

5. The non-transitory computer-readable recording medium as claimed in claim 2, wherein the updating includes erasing the label-attached image generated from the stroke image of the specific character from the label-attached image that form the character image of the plurality of recognized characters and inserting the label-attached image of the stroke image of the target replacement character into a position corresponding to a position of the erased label-attached image.

6. The non-transitory computer-readable recording medium as claimed in claim 2,
wherein the updating includes replacing stroke information of the specific character included in the stroke information of the plurality of recognized characters that are stored in a memory, and
wherein the stroke information of the specific character is replaced with stroke information of the corrected target replacement character.

7. The non-transitory computer-readable recording medium as claimed in claim 4, wherein the method includes
determining whether a circumscribing frame of the character image of the specific character overlaps with a circumscribing frame of the character image of a character that is adjacent to the specific character when the specific character is designated,
determining whether the value associated with the stroke image of the specific character is included in the values of the list when the circumscribing frames are determined to overlap with each other, and
subtracting the value associated with the stroke image of the specific character from the total of the values associated with each of the plurality of stroke images when the value associated with the stroke image of the specific character is determined to be included in the values of the list, and
erasing the value associated with the stroke image of the specific character from the values of the list.

8. The non-transitory computer-readable recording medium as claimed in claim 1, wherein the correcting includes
matching the height and the width of a circumscribing frame of the character image of the target replacement character with the height and the width of a circumscribing frame of the character image of the specific character, and
matching the coordinates of the circumscribing frame of the character image of the target replacement character with the coordinates of the character image of the specific character.

9. A handwritten character correction apparatus comprising:
a memory; and
a processor that causes a computer to execute a process including
correcting at least one of a character image of a target replacement character or stroke information of the target replacement character, in response to a designation of a specific character among a plurality of recognized characters from handwriting input and an input of the target replacement character that is to replace the specific character, and
updating at least one of a character image of the plurality of recognized characters or a stroke image of the plurality of recognized characters by utilizing at least a corrected one of the character image of the target replacement character or the stroke information of the target replacement character;
wherein the at least one of the character image of the target replacement character or the stroke information of the target replacement character is corrected based on coordinate information corresponding to the specific character, and
wherein the coordinate information is generated from at least one of the character image of the plurality of recognized characters or the stroke information of the plurality of recognized characters that are stored in the memory.

10. A method for correcting a handwritten character, the method comprising:
correcting at least one of a character image of a target replacement character or stroke information of the target replacement character, in response to a designation of a specific character among a plurality of recognized characters from handwriting input and an input of the target replacement character that is to replace the specific character; and
updating at least one of a character image of the plurality of recognized characters or a stroke image of the plurality of recognized characters by using at least a corrected one of the character image of the target replacement character or the stroke information of the target replacement character;
wherein the at least one of the character image of the target replacement character or the stroke information of the target replacement character is corrected based on coordinate information corresponding to the specific character; and
wherein the coordinate information is generated from at least one of the character image of the plurality of recognized characters or the stroke information of the plurality of recognized characters that are stored in a memory.
